(19) United States
(12) Patent Application Publication
(10) Pub. No.: US 2025/0317702 A1
(43) Pub. Date: Oct. 9, 2025

(54) RENDERING VOLUMETRIC AUDIO SOURCES

(71) Applicant: Telefonaktiebolaget LM Ericsson (publ), Stockholm (SE)

(72) Inventor: Werner DE BRUIJN, Stockholm (SE)

(73) Assignee: Telefonaktiebolaget LM Ericsson (publ), Stockholm (SE)

(21) Appl. No.: 18/704,354

(22) PCT Filed: Oct. 25, 2022
(86) PCT No.: PCT/EP2022/079693

§ 371 Date: Apr. 24, 2024

Related U.S. Application Data
(60) Provisional application No. 63/271,509, filed on Oct. 25, 2021.

(51) Int. Cl. H04S 7/00

(52) U.S. Cl. CPC H04S 7/302; H04S 2400/11; H04S 2400/13

(57) ABSTRACT

A method for rendering an audio source using a plurality of virtual sources is provided. The plurality of virtual sources includes a first virtual source. The method comprises obtaining a target distance gain value that was derived using a target distance gain function for the audio source and a reference distance value indicating a distance between a listening position and a reference point for the audio source. The method further comprises deriving a first distance gain correction value for at least the first virtual source using the target distance gain value. The method further comprises rendering the audio source using the derived first distance gain correction value and a signal for the first virtual source.

### TECHNICAL FIELD

This disclosure relates to methods and apparatus for rendering an audio source.

### BACKGROUND

An extended reality (XR) scene (e.g., a virtual reality (VR) scene, an augmented reality (AR) scene, or a mixed reality (MR) scene) may contain many different types of audio sources (a.k.a., “audio objects”) that are distributed throughout the XR scene. Many of these audio sources have specific, clearly defined locations in the XR scene and can be considered as point-like sources. Hence, these audio sources are typically rendered to a listener as point-like audio sources.

However, an XR scene often also contains audio sources that are non-point-like, meaning that they have a certain extent in one or more dimensions (e.g., width and/or height). Such non-point-like audio sources are referred to herein as “volumetric” audio sources (a.k.a., “extended audio sources”).

FIG. 1 shows an exemplary XR environment 100. In the XR environment 100, a listener 104 is standing in front of a volumetric audio source 102 which, in this example, is a waterfall. The waterfall 102 has a distinct spatially-heterogeneous character. Also because the actual extent of the audio source 102 is complex, the actual extent of the audio source 102 may be simplified into simple extent 120. The simple extent 120 of the audio element 102 may be used for rendering the audio source 102 (e.g., the simplified extent 120 is used to determine the placement of virtual loudspeakers that are used to render the audio source).

In the XR environment 100, the listener 104 located in front of the audio source 102 may hear audio from the audio source 102. The audio from the audio source 102 that the listener 104 hears may vary based on a distance between the listener 104 and the audio source 102. This variation of the audio along the distance between the listener 104 and the audio source 102 may be expressed as a volumetric distance gain function.

The distance gain function of an audio source (a.k.a., “distance attenuation function”) describes how the relative audio level of the audio source (a.k.a., “sound source”) changes as a function of the distance between the listener and the audio source. The distance gain may be defined relative to a reference distance where the distance gain is defined to be 1 (or 0 dB), and is an inherent property of the audio source. It is independent of the level of the audio signal used for rendering the audio source. In other words, it is independent of the “volume control” of the audio source, or the signal level of the signal going into the audio source (the “input signal level”).

For real-world sound sources, the phenomenon of distance gain arises due to the geometrical spreading of the sound waves that are radiated by the source, which causes the energy of the sound source to be spread over an increasingly large surface as the sound propagates further away from the source.

In acoustics theory, various prototype sound source types exist with corresponding theoretical prototype distance gain functions. The simplest prototype source is the point source, which has a distance gain function that varies as 1/r (with r the distance to the point source). This can be understood from the fact that a point source radiates spherical sound waves, so that at any distance r from the source, the sound energy is spread over a spherical surface of size 4πr². So, the energy passing through a single point in space decreases as 1/r², meaning that the pressure (or gain, in terms of an audio source) varies as 1/r. Another prototype sound source is an infinite line source, which has a distance gain function that varies as 1/sqrt(r). This can be understood from the fact that an infinite line source radiates cylindrical sound waves, so that the surface over which the radiated sound energy is spread varies as 1/r (as the circumference of a circle is given by 2πr). From this it follows that the pressure (gain) varies as 1/sqrt(r). Yet another prototype sound source is an infinite planar source, which has a distance gain function that is constant, i.e., the level does not change as a function of distance to the source.

In real life, sound sources never behave exactly as one of these prototype sources. Rather, depending on various properties of the source such as its dimensions and its radiation characteristics, its distance gain behavior may be anywhere in the spectrum between the behavior of a point source and of an infinite planar source, with the position within this spectrum itself depending on the distance. For example, at close distances the source may have a distance gain behavior like a line source (with 1/sqrt(r) behavior), while far away it may behave like a point source, with a gradual change between these two extremes at intermediate distances. Another source may have a distance gain behavior similar to that of an infinite planar source at very close distances (i.e. when the listener is close to the source), and to that of a point source when the listener is far away from the source.

In rendering volumetric audio sources in an XR system, a volumetric distance gain model may model this volumetric distance gain function (e.g., such as the volumetric distance gain function for the audio source 102). Examples of such a model are described in WO 2021/121698 and U.S. Patent Publication No. 2021/0306792, the disclosure of each of which is hereby incorporated by reference in its entirety.

The volumetric distance gain derived from this volumetric distance gain function is a distance gain corresponding to a sound source with the dimensions of the volumetric audio source at a particular distance (e.g., 106) from a reference point (e.g., 112) of the audio source (e.g., 102). There are different ways to set the reference point 112 of the audio source 102. For example, as shown in FIG. 1, the reference point 112 of the audio source 102 may be the point on the audio source extent 120 that is closest to the listening position 180.

In case the audio source 102 is rendered with a single virtual loudspeaker positioned at the reference point 112, the correct volumetric distance gain function for the audio source 102 (i.e., the variation of the relative audio level from the audio source as the distance between the listener 104 and the audio source 102 changes) can be realized by simply applying the volumetric distance gain from the volumetric distance gain model to the single virtual loudspeaker.

### SUMMARY

Certain challenges exist. For example, rendering the audio source 102 with a single virtual loudspeaker generally does not result in the desired spatial experience which may include conveying an auditory impression of the size of the volumetric audio source 102 to the listener 104.

One way to convey an auditory impression of the size of the volumetric audio source 102 to the listener 104 is to render the audio source 102 using multiple virtual loudspeakers positioned on or with respect to the extent of the audio source 102. Doing so, however, may complicate the realization of the correct volumetric distance gain for the volumetric audio source 102 because the total level of the audio at any listening position is now determined by contributions from multiple individual virtual loudspeakers, each having their own associated distance gain function.

Accordingly, in one aspect, there is provided a method for rendering an audio source using a plurality of virtual sources. The plurality of virtual sources includes a first virtual source. The method comprises obtaining a target distance gain value, wherein the target distance gain value was derived using a target distance gain function for the audio source and a reference distance value indicating a distance between a listening position and a reference point for the audio source. The method further comprises deriving a first distance gain correction value for at least the first virtual source using the target distance gain value. The method further comprises rendering the audio source using the derived first distance gain correction value and a signal for the first virtual source.

In another aspect, there is provided a method for rendering an audio source using a multi-channel input signal and a set of virtual sources. The method comprises obtaining a target distance gain value, deriving a common distance gain correction value for the set of virtual sources using the target distance gain value, and rendering the audio source using the derived common distance gain correction value and audio signals for the set of virtual sources. The set of virtual sources comprises a first cluster of one or more virtual sources associated with a first channel of the multi-channel input signal and a second cluster of one or more virtual sources associated with a second channel of the multi-channel input signal. The first cluster and the second cluster share at least one shared virtual source. An audio signal for said at least one shared virtual source is derived based on a weight and a sum of signals associated with the first and second channels. The common distance gain correction value is calculated based at least on the weight.

In another aspect, there is provided a method for rendering an audio source represented by at least a first virtual source and a second virtual source. The method comprises obtaining a reference distance value indicating a distance between a listening position and a reference point for the audio source; and obtaining a first distance value indicating a distance between the listening position and the position of the first virtual source. The method also comprises deriving a target distance gain value using the reference distance value, deriving a first distance gain value using the first distance value, deriving a first distance gain correction value for the first virtual source using the target distance gain value and the first distance gain value, and rendering the audio source using the first distance gain correction value and a first signal for the first virtual source.

In another aspect, there is provided a method for rendering an audio source using a set of virtual sources. The method comprises obtaining a first virtual source correlation control parameter value indicating a first correlation among the virtual sources included in the set or a signal correlation control parameter value indicating a correlation between audio signals from which signals for the virtual sources in the set are derived. The method further comprises obtaining a first distance gain correction value for uncorrelated virtual sources or uncorrelated audio signals from which signals for one or more virtual sources included in the set are generated. The method further comprises determining a common distance gain correction value based on (i) the first virtual source correlation control parameter value or the signal correlation control parameter value, and (ii) the first distance gain correction value. The method further comprises, based on the common distance gain correction value, rendering the audio source.

In another aspect, there is provided a computer program comprising instructions which when executed by processing circuitry cause the processing circuitry to perform the method of at least one of the embodiments described above.

In another aspect, there is provided a carrier containing the computer program of the embodiments described above, wherein the carrier is one of an electronic signal, an optical signal, a radio signal, and a computer readable storage medium.

In another aspect, there is provided an apparatus for rendering an audio source using a plurality of virtual sources. The plurality of virtual sources includes a first virtual source. The apparatus is configured to obtain a target distance gain value, wherein the target distance gain value was derived using a target distance gain function for the audio source and a reference distance value indicating a distance between a listening position and a reference point for the audio source. The apparatus is configured to derive a first distance gain correction value for at least the first virtual source using the target distance gain value. The apparatus is configured to render the audio source using the derived first distance gain correction value and a signal for the first virtual source.

In another aspect, there is provided an apparatus for rendering an audio source using a multi-channel input signal and a set of virtual sources. The apparatus is configured to obtain a target distance gain value, derive a common distance gain correction value for the set of virtual sources using the target distance gain value, and render the audio source using the derived common distance gain correction value and audio signals for the set of virtual sources. The set of virtual sources comprises a first cluster of one or more virtual sources associated with a first channel of the multi-channel input signal and a second cluster of one or more virtual sources associated with a second channel of the multi-channel input signal. The first cluster and the second cluster share at least one shared virtual source. An audio signal for said at least one shared virtual source is derived based on a weight and a sum of signals associated with the first and second channels. The common distance gain correction value is calculated based at least on the weight.

In another aspect, there is provided an apparatus for rendering an audio source represented by at least a first virtual source and a second virtual source. The apparatus is configured to obtain a reference distance value indicating a distance between a listening position and a reference point for the audio source; obtain a first distance value indicating a distance between the listening position and the position of the first virtual source; and derive a target distance gain value using the reference distance value. The apparatus is further configured to derive a first distance gain value using the first distance value, derive a first distance gain correction value for the first virtual source using the target distance gain value and the first distance gain value, and render (s662) the audio source using the first distance gain correction value and a first signal for the first virtual source.

In another aspect, there is provided an apparatus for rendering an audio source using a set of virtual sources. The apparatus is configured to obtain a first virtual source correlation control parameter value indicating a first correlation among the virtual sources included in the set or a signal correlation control parameter value indicating a correlation between audio signals from which signals for the virtual sources in the set are derived. The apparatus is further configured to obtain a first distance gain correction value for uncorrelated virtual sources or uncorrelated audio signals from which signals for one or more virtual sources included in the set are generated. The apparatus is further configured to determine a common distance gain correction value based on (i) the first virtual source correlation control parameter value or the signal correlation control parameter value, and (ii) the first distance gain correction value; and based on the common distance gain correction value, render the audio source.

In another aspect, there is provided an apparatus comprising a memory; and processing circuitry coupled to the memory. The apparatus is configured to perform the method of at least one of the embodiments described above.

An advantage of the embodiments disclosed herein is that they enable determining a correction for a gain of an audio signal for each of multiple virtual loudspeakers used for rendering a volumetric audio source such that a correct volumetric distance gain function is realized for the volumetric audio source at any listener position.

### BRIEF DESCRIPTION OF THE DRAWINGS

The accompanying drawings, which are incorporated herein and form part of the specification, illustrate various embodiments.

FIG. 1 shows an exemplary VR environment 100.

FIG. 2 shows an exemplary virtual loudspeaker setup according to some embodiments.

FIG. 3A shows a scenario where the listener is far from the audio source.

FIG. 3B shows a scenario where the listener is close to the audio source.

FIG. 4 shows an arrangement of virtual loudspeakers for rendering the audio source according to some embodiments.

FIG. 5 shows an arrangement of virtual loudspeakers for rendering the audio source according to some embodiments.

FIG. 6A shows a process according to some embodiments.

FIG. 6B shows a process according to some embodiments.

FIGS. 7A and 7B show a system according to some embodiments.

FIG. 8 illustrates a system according to some embodiments.

FIG. 9. illustrates a signal modifier according to an embodiment.

FIG. 10 is a block diagram of an apparatus according to some embodiments.

FIG. 11 shows an arrangement of five virtual sources for rendering an audio source.

FIG. 12A shows a process according to some embodiments.

FIG. 12B shows a process according to some embodiments.

### DETAILED DESCRIPTION

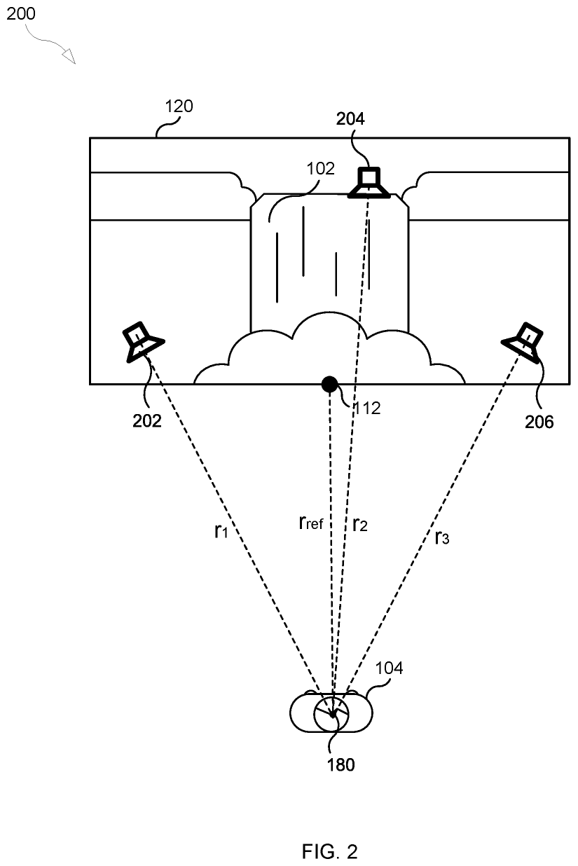

FIG. 2 shows an exemplary virtual loudspeaker setup 200 according to some embodiments. In the setup 200, the volumetric audio source 102 is rendered to the listener 104 at a listening position 180 using three discrete virtual loudspeakers (a.k.a., “virtual sources”)—a first virtual source 202, a second virtual source 204, and a third virtual source 206. The number and/or the positions of the virtual sources shown in FIG. 2 are provided for illustration purpose only and do not limit the embodiments of this disclosure in any way. Also, the term “virtual loudspeaker” should not be interpreted as limiting the type of virtual source that can be used in any way, i.e., the term may refer to any type of virtual source that is used to render the volumetric audio source 102, which may or may not have the properties of an actual “loudspeaker.”

The frequency-dependent complex sound pressure pₙ at the listener position due to each virtual source n (where n=1 for the first virtual source 202, n=2 for the second virtual source 204, and n=3 for the third virtual source 206) located at a distance rₙ from the listening position can be written as a product of a frequency-dependent amplitude aₙ, and a frequency-dependent unit-magnitude complex phase term θₙ (e.g., θₙ=exp(j*ϕₙ), with ϕₙ the frequency-dependent phase angle of virtual source n, in radians):

$${p}_{n} ( {r}_{n} ) = {a}_{n} ( {r}_{n} ) {θ}_{n} ( {r}_{n} ) . \qquad ( 1 )$$

The total sound pressure of the rendered audio source 102 at the listening position 180 is the sum of the individual complex sound pressures pₙ, and the total sound energy at the listening position 180 may be calculated from its square as follows:

$${p}_{total}^{2} = {\vert {\sum }_{n = 1}^{N} {p}_{n} ( {r}_{n} ) \vert}^{2} , \qquad ( 2 )$$

where N is the number of virtual sources used for rendering the audio source (e.g., in FIG. 2, N is equal to 3).

The correct volumetric distance gain function for the audio source 102 may be a target volumetric distance gain function (herein after “target distance gain function”) that is for producing a target audio effect that the content provider wants to produce for the audio source 102 (e.g., such that the rendered audio source has a distance gain behavior similar to that of a real source with the corresponding dimensions). Alternatively, the content provider may specify a specific desired distance gain behavior for the source 102 (e.g., such that the source has the distance gain function of a line source, or a point source). In yet other use cases, the renderer may independently derive an appropriate target distance gain function for the audio source 102, e.g. using information about its dimensions.

For example, the content provider of the XR environment 100 may want to change the audio rendered to the listener 104 in a particular way as the distance of the listener 104 changes with respect to the audio source 102. The target distance gain function models such change of the audio. The target distance gain function may be a function of the size (e.g., width) of the extent (either actual or simplified extent) of the audio source 102. An example of the target distance gain function is as follows:

$${g}_{target} = \{ \begin{matrix}{( {L}_{1} \times max ( {L}_{2} , {L}_{1} / 6 ) )}^{- 0.25} \times {( {L}_{2} / 6 )}^{- 0.375} \times {D}^{- 0.125} ; D < ( {L}_{2} / 6 ) \\ {( {L}_{1} \times max ( {L}_{2} , {L}_{1} / 6 ) )}^{- 0.25} \times {D}^{- 0.5} ; ( {L}_{2} / 6 ) \leq D < max ( {L}_{2} {L}_{1} / 6 ) \\ {( {L}_{1} )}^{- 0.25} \times {D}^{- 0.75} ; max ( {L}_{2} , {L}_{1} / 6 ) \leq D < {L}_{1} \\ {D}^{- 1} ; D \geq {L}_{1}\end{matrix}$$

where L₁ is the width of the extent 120, L₂ is the height of the extent 120, D (a.k.a., r_{ref}) is the distance between a reference point for audio source 102 and the position of the listener 104.

Other examples of the target distance gain function are provided in U.S. Patent Publication No. 2021/0306792, which is hereby incorporated by reference.

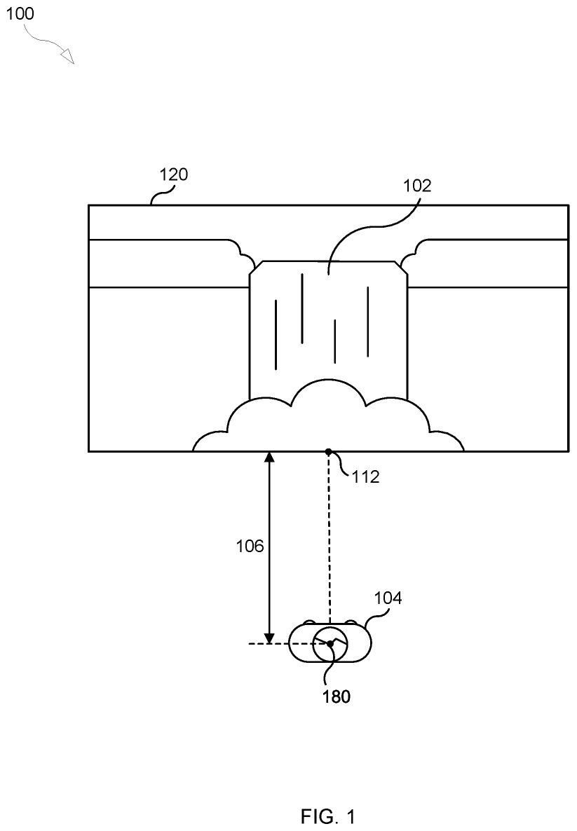

This target distance gain function is expressed by g_{target}(r_{ref}), where r_{ref} denotes the distance from the listening position 180 to a reference point for the audio source 102. In FIGS. 1 and 2, the reference point 112 is the point on the extent 120 that is closest to the listening position 180.

The amplitude function aₙ at the listening position may for each virtual source n be expressed as the product of the distance gain function gₙ(rₙ) of virtual source n and a source gain function sₙ(rₙ) for virtual source n:

$${a}_{n} ( {r}_{n} ) = {s}_{n} ( {r}_{n} ) {g}_{n} ( {r}_{n} ) . \qquad ( 3 )$$

The source gain sₙ(rₙ) represents the amplitude of the signal that is output by virtual source n (either absolute or relative to the other virtual sources) and may include the effects of the amplitudes of the input signal(s) of source 102 (either absolute or relative to each other) and of gain components due to any signal processing that has been applied in generating the signal for the virtual source n from the input signal(s) of source 102 (or from intermediate signals derived from the input signal(s) of source 102). For example, it may include the combined effects of filtering gains, panning gains, upmixing gains, downmixing gains, mapping gains, or matrixing gains for virtual source n that result from, respectively, filtering, panning, upmixing, downmixing or matrixing the input signal(s) of source 102 to the individual virtual source, or it may include a gain that is related to a sensitivity of virtual source n relative to the other virtual sources, or in general any gain component resulting from any spatial and/or temporal processing that is carried out on the input signal(s) of source 102 to generate the signal to be output by virtual source n. Note that in addition to being dependent on the distance between the virtual source n and the listening position 180, rₙ, the source gain sₙ(rₙ) may depend on other variables as well. Specifically, the source gain sₙ(rₙ) may depend on frequency and on the distance r_{ref} between the listening point 180 and the reference point for the audio source 102.

In many cases, for example, when the audio source 102 only has one input signal, or all input signals of the audio source 102 have the same amplitude, the source gain sₙ may be independent of the input signal amplitude(s) and may be determined completely by the gain components that are due to the signal processing used to generate the signal for virtual source n.

The distance gain function of each virtual source is used for generating an audio signal of which the level changes as the distance between the location of each virtual source and the listener position changes. Example embodiments using different distance gain functions for the virtual sources are provided below.

Now, in order to realize the target distance gain function g_{target}(r_{ref}) for audio source 102, the objective is to find distance gain correction functions cₙ for the virtual sources, such that when these distance gain correction functions are applied to the signals output by the N virtual sources, the total distance gain value at the listening position 180 resulting from the N virtual sources may be equal to a value of the target distance gain function at the listening position 180.

In other words, we modify the amplitude function aₙ of each virtual source by multiplying it by the distance gain correction function cₙ:

$${a}_{n}^{′} = {c}_{n} {a}_{n} ( {r}_{n} ) = {c}_{n} {s}_{n} ( {r}_{n} ) {g}_{n} ( {r}_{n} ) ,$$

where aₙ′ is the modified amplitude function for virtual source n.

In some embodiments, the distance gain correction function cₙ for a virtual source is a function of the distance rₙ between the listening position 180 and that virtual source, i.e.: cₙ=cₙ(rₙ).

In other embodiments, the distance gain correction function cₙ for a virtual source is a function of the distance r_{ref} between the listening position 180 and the reference point for the audio source 102, i.e.: cₙ=cₙ(r_{ref}).

Combining the equations (1)-(3) and equating this to the square of the desired target distance gain function g_{target}(r_{ref}), the following equation can be obtained. For simple explanation, the equation below is referred to as an “objective equation:”

$${{g}_{target}^{2} ( {r}_{r e f} ) = \vert {\sum }_{n = 1}^{N} {c}_{n} {s}_{n} ( {r}_{n} ) {g}_{n} ( {r}_{n} ) {θ}_{n} ( {r}_{n} ) \vert}^{2} , \qquad ( 4 )$$

where N is the number of virtual sources used for rendering the audio source (e.g., in FIG. 2, N is equal to 3). The right-hand side of equation (4) may be interpreted as the square of the realized distance gain function for the audio source 102 rendered with the N virtual loudspeakers when the distance gain correction functions cₙ are applied (Note that when all cₙ's are equal to 1, the right-hand side of equation (4) represents the square of the realized distance gain function without the distance gain correction).

In some embodiments, gain components that have no relevance for the distance gain behavior of the rendered source 102 may be excluded from the source gains sₙ(rₙ) before these are inserted into equation (4).

For example, in some embodiments a gain component that is common for all N virtual sources and does not depend on distance may be excluded from the source gains sₙ(rₙ). One example of this is an overall gain setting for the audio source 102 that controls its general level.

In other embodiments, the source gains sₙ(rₙ) of the N virtual sources may be normalized before being inserted into equation (4) such that the largest among them has a value of 1, i.e.:

$${s}_{n} ( {r}_{n} ) = \frac{{s}_{n , non - normalized} ( {r}_{n} )}{{max}_{n = 1 … N} ( {s}_{n , non - normalized} ( {r}_{n} ) )} ,$$

where s_{n,non-normalized}(rₙ) is the source gain for virtual source n before normalization.

Similarly, in some embodiments, phase components that have no relevance for the distance gain behavior of the rendered source 102 may be excluded from the phase factors θₙ(rₙ) before these are inserted into equation (4).

For example, in some embodiments a phase component that is common for all N virtual sources and/or does not depend on distance may be excluded from the phase factors θₙ(rₙ).

From the equation (4), it is possible to derive distance gain correction functions cₙ for the virtual sources that result in the target distance gain function for the rendered audio source 102. The general way to derive these distance gain correction functions is to solve equation (4) for cₙ, n=1 . . . N, for example as a least-squares optimization problem where the difference between the target distance gain function and the realized distance gain function is minimized, i.e., by minimizing:

$${{g}_{target}^{2} ( {r}_{r e f} ) - \vert {\sum }_{n = 1}^{N} {c}_{n} {s}_{n} ( {r}_{n} ) {g}_{n} ( {r}_{n} ) {θ}_{n} ( {r}_{n} ) \vert}^{2} .$$

A problem with solving the equation (4) in its general form (e.g., as the least squares optimization problem as described above), is that for each specific value of the distance r_{ref} between the reference point of the audio source 102 and the listener position 180 there is an infinite number of possible combinations of distance gain correction functions cₙ that satisfy the equation. An alternative could be to use a fixed distance gain correction factor cₙ for each virtual source (i.e., independent of distance), and then solve the equation or minimization problem for a number M≥N of values of r_{ref} at the same time. However, while resulting in a unique solution, this would only guarantee a correct distance gain value for the rendered audio source 102 at the M specific distances. Also, it would not provide any control over other important aspects of the solution besides realization of the target distance gain function, e.g., spatial impression of the solution. Accordingly, embodiments of this disclosure provide different ways of solving the equation (4) under different conditions such that appropriate distance gain correction functions for the virtual sources 202, 204, and 206 can be determined.

As shown in the equation (4), the distance gain correction function cₙ for an individual virtual source n may depend on the target volumetric distance gain function g_{target}, the distance r_{ref} between the reference point 112 and the listener position 180, the distances rₙ (n=1 . . . N) between the individual virtual sources and the listener position 180, and the source gains, phase terms and distance gain functions of the individual virtual sources.

If all of the virtual sources 202, 204, and 206 can be considered independent (i.e., they are uncorrelated sources), then the squared total pressure for the rendered audio source 102 at the listening position 180 may be expressed as follows:

$${p}_{total}^{2} = {\sum }_{n = 1}^{N} {\vert {p}_{n} ( {r}_{n} ) \vert}^{2} , \qquad ( 5 )$$

because in evaluating the square operator in equation (2) the cross terms pₙpₘ∀n≠m, are all zero for uncorrelated sources.

As a result, and using the fact that the phase terms θₙ(rₙ) are unit-magnitude, equation (4) may be simplified to:

$${g}_{target}^{2} ( {r}_{r e f} ) = {\sum }_{n = 1}^{N} {( {c}_{n} {s}_{n} ( {r}_{n} ) {g}_{n} ( {r}_{n} ) )}^{2} . \qquad ( 6 )$$

As already mentioned above, for each distance r_{ref} between the reference point of the audio source 102 and a specific listening position, there is an infinite number of possible solutions to the general problem of equality (4) and/or (6).

In some embodiments, in order to realize the target distance gain function for the audio source 102, a single common distance gain correction function, C, may therefore be used and applied for all virtual sources 202, 204, and 206, instead of using individual distance gain correction functions for the individual virtual sources. The common distance gain correction function C may be a function of the distance r_{ref} between the reference point of the audio source 102 and the listener position 180. In other words:

$$\begin{matrix}{c}_{n} = C ( {r}_{r e f} ) , & ( n = 1 … N ) ,\end{matrix} \qquad ( 7 )$$

where N is the number of virtual sources used for rendering the audio source 102. In FIG. 2, N is equal to 3.

Since the same distance gain correction function is now applied to all virtual sources 202, 204, and 206, and the distance r_{ref} is the same for all virtual sources, the same distance gain correction value is applied to all virtual sources. Using the common distance gain correction function, equality (6) may be solved as:

$$C ( {r}_{r e f} ) = \frac{{g}_{target} ( {r}_{r e f} )}{\sqrt{{\sum }_{n = 1}^{N} {s}_{n}^{2} ( {r}_{n} ) {g}_{n}^{2} ( {r}_{n} )}} . \qquad ( 8 )$$

As shown in equation (8), the common distance gain correction function C(r_{ref}) that is applied to each virtual source 202, 204, and 206 is equal to the ratio of the target distance gain for the audio source 102, g_{target}, and the distance gain of the rendered audio source 102 without correction (the denominator of equation (8)), and may be determined based on (i) the target distance gain value of the audio source 102 for the listener 104 positioned at the distance r_{ref} from the reference point 112, (ii) the distance gain value (e.g., g₁(r₁)) of each virtual source at the listener position 180 and (iii) the source gain value (e.g. s₁(r₁)) of each virtual source.

1. Scenario where the Listener is Far Away from the Audio Element

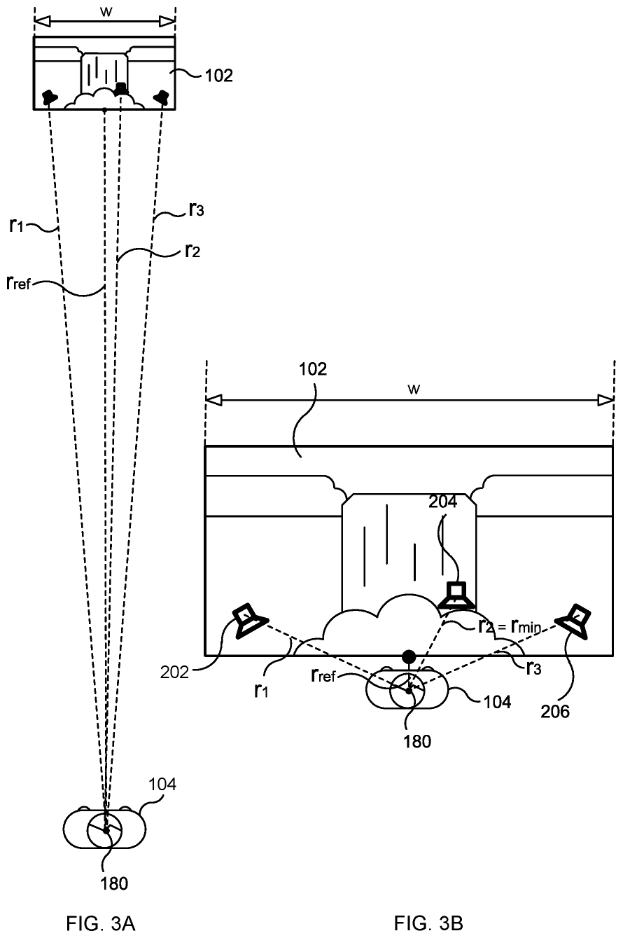

As illustrated in FIG. 3A, when the listener 104 is far away from the audio source 102, the distance to the reference point, r_{ref}, would be very large. In such case, since the distance between the listener 104 and the audio source 102 is much larger than the size of the extent (e.g., width w), the distance r_{ref} and rₙ (r₁, r₂, r₃) become essentially equal.

Thus, if the same distance gain function g_{common} is used for all virtual sources 202, 204, and 206, then, based on the equation (8), the distance gain correction function for each of the virtual sources 202, 204, and 206 becomes:

$$\begin{matrix}C ( {r}_{r e f} ) = \frac{1}{\sqrt{{\sum }_{n = 1}^{N} {s}_{n}^{2} ( {r}_{r e f} )}} \times \frac{{g}_{target} ( {r}_{r e f} )}{{g}_{c o m m o n} ( {r}_{r e f} )} , & {r}_{r e f} ≫ size of extent ( w ) .\end{matrix} \qquad ( 9 )$$

If all source gains are equal to one, it follows from equation (9) that:

$$\begin{matrix}C ( {r}_{r e f} ) = \frac{1}{\sqrt{N}} \times \frac{{g}_{target} ( {r}_{r e f} )}{{g}_{c o m m o n} ( {r}_{r e f} )} , & {r}_{r e f} ≫ size of extent ( w ) .\end{matrix} \qquad ( 9 a )$$

Otherwise, the equation (8) can be expanded as follows (for the example of FIG. 3A where N=3):

$$C ( {r}_{r e f} ) = \frac{{g}_{target} ( {r}_{ref} )}{\sqrt{{\sum }_{n = 1}^{N} {s}_{n}^{2} ( {r}_{n} ) {g}_{c o m m o n}^{2} ( {r}_{n} )}} = \frac{{g}_{target} ( {r}_{ref} )}{\sqrt{{s}_{1}^{2} ( {r}_{1} ) {g}_{c o m m o n}^{2} ( {r}_{1} ) + {s}_{2}^{2} ( {r}_{2} ) {g}_{c o m m o n}^{2} ( {r}_{2} ) + {s}_{3}^{2} ( {r}_{3} ) {g}_{c o m m o n}^{2} ( {r}_{3} )}} \qquad ( 9 )$$

2. Scenario where the Listener is Very Close to the Audio Element

As shown in FIG. 3B, there may be a scenario where the listener 104 is very close to the audio element 102, and thus the distance between the listener 104 and a virtual source is very small. More specifically, in FIG. 3B, the distance between the listening position 180 and the second virtual source 204 is substantially small as compared to (i) the distance between the listening position 180 and the first virtual source 202 and (ii) the distance between the listening position 180 and the third virtual source 206. Thus, since distance gain functions are always monotonously decreasing as function of distance, g_{common}(r₂)>>g_{common}(r₁) and g_{common}(r₃).

Therefore, the equation (8) can further be simplified to:

$$C ( {r}_{ref} ) = \frac{1}{{s}_{min} ( {r}_{min} )} \times \frac{{g}_{target} ( {r}_{ref} )}{{g}_{c o m m o n} ( {r}_{min} )} , {r}_{ref} ≪ size of extent . \qquad ( 10 )$$

where the ‘min’ subscript refers to the virtual source that is closest to the listener position 180 among the virtual sources used for rendering the audio element 102. So, rₘᵢₙ is the distance between the listener position 180 and the location of the virtual source that is closest to the listener position 180 among the virtual sources used for rendering the audio element 102, and sₘᵢₙ(rₘᵢₙ) is the source gain for that virtual source. In this example, since the virtual source 204 is closest to the listener position 180, rₘᵢₙ=r₂ and sₘᵢₙ=s₂.

Like the equation (6) for uncorrelated sources, the non-uniqueness problem of the general equation (4) can also be solved by using a single common distance gain correction function C(r_{ref}) instead of individual distance gain correction functions for the individual virtual sources, leading to:

$$C ( {r}_{ref} ) = \frac{{g}_{target} ( {r}_{ref} )}{\vert {\sum }_{n = 1}^{N} {s}_{n} ( {r}_{n} ) {g}_{n} ( {r}_{n} ) {θ}_{n} ( {r}_{n} ) \vert} , \qquad ( 8 a )$$

where again the denominator represents the distance gain of the rendered audio source 102 without correction.

The equations above are valid for arbitrary distance gain functions gₙ of the virtual sources 202, 204, and 206. Embodiments for a few specific choices that may be of particular interest in applications are discussed below.

### 3. Using a Distance Gain Function of a Point Source as a Distance Gain Function for Each Virtual Source

Each of the individual virtual sources 202, 204, and 206 may be rendered using the distance gain function of a point source such that the distance gain function gₙ of each virtual source 202, 204, and 206 may be expressed as follows:

$${g}_{n} ( {r}_{n} ) = \frac{1}{{r}_{n}} . \qquad ( 11 )$$

This may be a very common use case, as in many applications a standard audio object renderer may be used to do the actual rendering of the virtual loudspeakers to the user as standard (point source) audio objects.

If the distance gain function of each of the virtual sources 202, 204, and 206 is the same as the distance gain function of a point source, in the scenario where the distance between the listener 104 and the audio element 102 is much larger than the size of the extent (e.g., width w), using the equation (9), the common distance gain correction function for uncorrelated virtual sources may be determined as follows:

$$C ( {r}_{ref} ) = \frac{1}{\sqrt{{\sum }_{n = 1}^{N} {s}_{n}^{2} ( {r}_{r e f} )}} \times \frac{{g}_{target} ( {r}_{ref} )}{{g}_{c o m m o n} ( {r}_{ref} )} = \frac{1}{\sqrt{{\sum }_{n = 1}^{N} {s}_{n}^{2} ( {r}_{ref} )}} \times {r}_{ref} \times {g}_{target} ( {r}_{ref} ) , {r}_{ref} ≫ size of extent . \qquad ( 12 )$$

On the other hand, in the scenario where the distance between the listener 104 and the audio element 102 is much smaller than the size of the extent (e.g., width w), using the equation (10), the common distance gain correction function for uncorrelated virtual sources may be determined as follows:

$$C ( {r}_{ref} ) = \frac{1}{{s}_{min} ( {r}_{min} )} \times \frac{{g}_{target} ( {r}_{ref} )}{{g}_{n} ( {r}_{min} )} = \frac{1}{{s}_{min} ( {r}_{min} )} \times {r}_{min} \times {g}_{target} ( {r}_{ref} ) , {r}_{ref} ≪ size of extent . \qquad ( 13 )$$

### 4. Using a Target Distance Gain Function of the Volumetric Audio Source as a Distance Gain Function for Each Virtual Source

Another possible choice for the common distance gain function g_{common} for virtual sources 202, 204, or 206 is using the target distance gain function for the audio source 102 (which, as explained, may be based on the size of the extent of the audio source 102 or defined in some other way) evaluated for a distance between each virtual source 202, 204, or 206 and the listening position 180. In other words,

$${g}_{c o m m o n} ( {r}_{n} ) = {g}_{target} ( {r}_{n} ) , \qquad ( 14 )$$

In this scenario, if, as illustrated in FIG. 3A, the distance r_{ref} is very large such that the distances r_{ref} and rₙ (r₁, r₂, r₃) become essentially equal, the common distance gain correction function for uncorrelated virtual sources 202, 204, or 206 becomes:

$$C ( {r}_{ref} ) = \frac{1}{\sqrt{{\sum }_{n = 1}^{N} {s}_{n}^{2} ( {r}_{ref} )}} \times \frac{{g}_{target} ( {r}_{ref} )}{{g}_{c o m m o n} ( {r}_{ref} )} = \frac{1}{\sqrt{{\sum }_{n = 1}^{N} {s}_{n}^{2} ( {r}_{ref} )}} , {r}_{ref} ≫ size of extent . \qquad ( 15 )$$

On the other hand, as shown in FIG. 3B, when the listener 104 is very close to the audio element 102, the distance r_{ref} would be very small. In such a case, the equation (8) for uncorrelated virtual sources can be simplified to:

$$C ( {r}_{ref} ) = \frac{1}{{s}_{min} ( {r}_{min} )} \times \frac{{g}_{target} ( {r}_{ref} )}{{g}_{n} ( {r}_{min} )} = \frac{1}{{s}_{min} ( {r}_{min} )} \times \frac{{g}_{target} ( {r}_{ref} )}{{g}_{c o m m o n} ( {r}_{min} )} , {r}_{ref} ≪ size of extent . \qquad ( 16 )$$

### 5. Using a Distance Gain Function Corresponding to a Part of the Extent of the Audio Source as a Distance Gain Function for Each Virtual Source

Another way to render each virtual source is using a distance gain function corresponding to a part of the extent of the audio source 102.

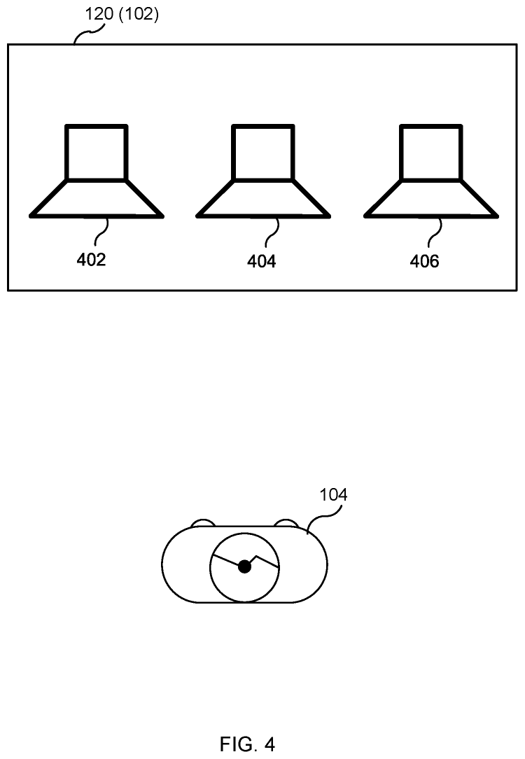

For example, as shown in FIG. 4, if the audio source 102 is rendered using 3 individual virtual sources 402, 404, and 406 that are uniformly distributed over the extent of the audio source 102, then each of the virtual sources 402, 404, and 406 may be rendered with a distance gain function of a volumetric audio source having ⅓ of the size of the extent of the audio source 102 (or, in general, 1/N of the size of the extent of the audio source 102, where N is the number of virtual sources used for rendering the audio source).

In case of uncorrelated virtual sources, the distance gain correction function for each virtual speaker 402, 404, or 406 may be calculated using the equation (8) (or using the more general equation (8a) for sources that are not uncorrelated), where gₙ is the distance gain function corresponding to the source segment represented by virtual source n. The distance gain functions gₙ may be derived using the same model that is used to derive the target distance gain function for the audio source 102 as a whole.

If all the segments each of which is represented by each virtual source 402, 404, or 406 have the same size (width and height) as shown in FIG. 4, then every segment has the same distance gain function and the function gₙ is the same for all virtual sources (i.e., gₙ=g_{common}=g₁=g₂=g₃). In this case, the equations (9) and (10) are also applicable (in the scenarios where the listening position is far away from the audio element or where the listening position is very close to the audio element).

As the number of the virtual sources used for rendering the audio element is steadily increased, the distance gain functions of the individual virtual sources become more and more like the distance gain function of a point source. On the other hand, as the number of virtual sources is decreased, the distance gain functions become more and more like the target distance gain function of the audio source 102 as a whole.

From a physics point of view this is exactly the desired behavior. Accordingly, as compared to the other embodiments described above—using a distance gain function of a point source as the distance gain function of each virtual source or using the target distance gain function of the audio source 102 as the distance gain function of each virtual source—, this embodiment provides a realistic way of rendering the audio source 102.

### 6. Using a Constant Value for the Distance Gain Function of Each Virtual Source

In some embodiments, e.g., for simplification purpose, the distance gain function of each virtual source may be set to be independent of distance, i.e., to not have any distant attenuation at all. For example, the distance gain function of each virtual source may be a constant value, e.g., gₙ=1.

If gₙ=1, it follows from the equation (8) (uncorrelated virtual sources) that:

$$C ( {r}_{ref} ) = \frac{{g}_{target} ( {r}_{ref} )}{\sqrt{{\sum }_{n = 1}^{N} {s}_{n}^{2} ( {r}_{ref} ) {g}_{n}^{2} ( {r}_{n} )}} = \frac{{g}_{target} ( {r}_{ref} )}{\sqrt{{\sum }_{n = 1}^{N} {s}_{n}^{2} ( {r}_{ref} )}} . \qquad ( 17 )$$

While using a constant value as a distance gain function for each virtual source may achieve the goal of realizing the target distance gain for the audio source at the listening position, it may not provide a realistic audio experience because one would expect that parts of an audio source that are further away from the listening position contribute less to the rendered audio.

On the other hand, this embodiment may be useful for generating an interesting effect. For example, this embodiment may be used to give the listener an increased or exaggerated sensation of the size of the volumetric audio source (Note that other spatial localization cues that are used by the human hearing system to create a sensation of “source size” are still maintained when rendering a volumetric source using this embodiment).

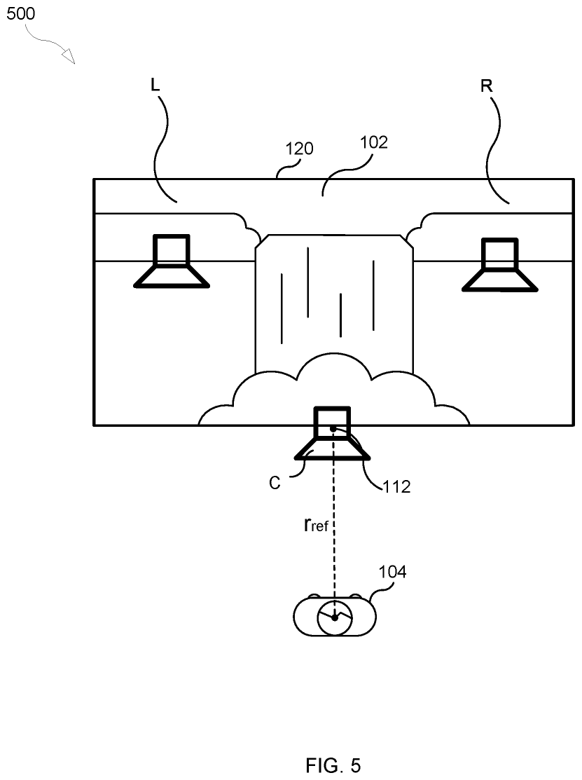

FIG. 5 shows a specific rendering configuration 500 for rendering the audio element 102 with three virtual sources L, R, and C. As shown in FIG. 5, two virtual sources L and R are placed at the left and right edges of the extent 120 of the audio element 102 and the virtual source C is placed at the reference point 112 of the extent 120. In FIG. 5, the reference point 112 is the point on the extent 120 that is closest to the position of the listener 104. Because the virtual source C is placed at the reference point 112, the distance between the virtual source C and the position of the listener 104 is equal to the reference distance r_{ref}.

### 6.1 Using a Distance Gain Function of a Point Source as a Distance Gain Function for Each Virtual Source

In the configuration 500, if the distance gain function of each virtual source L, R, or C is set to be equal to a distance gain function of a point source

$$( i . e . , {g}_{n} ( {r}_{n} ) = \frac{1}{{r}_{n}} )$$

and if a single common distance gain correction is applied for all virtual sources, the single common distance gain correction function may be derived using the equation (8) as follows (Note that r_{ref}=r_{C}):

$$C ( {r}_{c} ) = \frac{{g}_{target} ( {r}_{rc} )}{{( \frac{{s}_{C} ( {r}_{C} )}{{r}_{C}} )}^{2} + {( \frac{{s}_{L} ( {r}_{L} )}{{r}_{L}} )}^{2} + {( \frac{{s}_{R} ( {r}_{R} )}{{r}_{R}} )}^{2}} . \qquad ( 17 )$$

In some scenarios, the listener 104 may be located very far away from the audio source 102, as illustrated in FIG. 3A. In such scenarios, as explained above, r_{C}=r_{L} r_{R}. Then, the equation (17) becomes:

$$C ( {r}_{C} ) = \frac{1}{\sqrt{{s}_{C}^{2} ( {r}_{C} ) + {s}_{L}^{2} ( {r}_{C} ) + {s}_{R}^{2} ( {r}_{C} )}} \times {r}_{C} \times {g}_{target} ( {r}_{c} ) , {r}_{c} ≫ size of extent . \qquad ( 18 )$$

In other scenarios, the listener 104 may be located very close to the audio source 102, as illustrated in FIG. 3B. In such scenarios,

$${( \frac{1}{{r}_{C}} )}^{2} ≫ {( \frac{1}{{r}_{L}} )}^{2} or {( \frac{1}{{r}_{R}} )}^{2} .$$

Then, the equation (17) becomes:

$$C ( {r}_{C} ) = \frac{1}{{s}_{c} ( {r}_{c} )} \times {r}_{c} \times {g}_{target} ( {r}_{c} ) , {r}_{ref} ≪ size of extent . \qquad ( 19 )$$

As explained above, in some embodiments, the reference point (and thus the position of the virtual source C) is the point on the extent (i.e., a dynamic position dependent on the relative listening position) that is closest to the listener position. Thus, rₘᵢₙ=r_{C}.

### 6.2 Using a Target Distance Gain Function of the Volumetric Audio Source as a Distance Gain Function for Each Virtual Source

As discussed above, in some embodiments, the distance gain function of each individual virtual source C, L, or R may be set to be same as the target distance gain function of the audio source 102 (i.e., gₙ(rₙ)=g_{target}(rₙ)). In such embodiments, if a single common distance gain correction is applied for all virtual sources C, L, and R, the single common distance gain correction according to the equation (8) may be simplified to (with r_{ref}=r_{C}):

$$C ( {r}_{C} ) = \frac{{g}_{target} ( {r}_{C} )}{\sqrt{{s}_{C}^{2} ( {r}_{C} ) {g}_{target}^{2} ( {r}_{C} ) + {s}_{L}^{2} ( {r}_{L} ) {g}_{target}^{2} ( {r}_{L} ) + {s}_{R}^{2} ( {r}_{R} ) {g}_{target}^{2} ( {r}_{R} )}} . \qquad ( 20 )$$

As discussed above, in some scenarios, the listener 104 is located very far away from the audio source 102, as illustrated in FIG. 3A. In such scenarios, r_{C}=r_{L} r_{R}. Then, the equation (20) becomes:

$$C ( {r}_{C} ) = \frac{1}{\sqrt{{s}_{C}^{2} ( {r}_{C} ) + {s}_{L}^{2} ( {r}_{C} ) + {s}_{R}^{2} ( {r}_{C} )}} , {r}_{C} >> size of extent . \qquad ( 21 )$$

In other scenarios, the listener 104 is very close to the audio source 102, as illustrated in FIG. 3B. In such scenarios, g_{target}²(r_{C})>>g_{target}²(r_{L}) and g_{target}²(r_{R}). Then, the equation (20) becomes (with r_{ref}=rₘᵢₙ=r_{C}):

$$C ( {r}_{C} ) = \frac{1}{{s}_{C} ( {r}_{C} )} , {r}_{C} << size of extent . \qquad ( 22 )$$

### 6.3 Using a Target Distance Gain Function Corresponding to a Part of the Extent of the Audio Source as a Distance Gain Function of Each Virtual Source

In the scenarios where each virtual source is rendered with a distance gain function that corresponds to a part of the extent 120 of the audio source 102, the equation (8) becomes:

$${g}_{target}^{2} ( {r}_{ref} ) = \frac{1}{3} {g}_{target}^{2} ( {r}_{C} ) + {C}_{LR}^{2} ( {g}_{target}^{2} ( {r}_{L} ) + {g}_{target}^{2} ( {r}_{R} ) ) \qquad ( 23 )$$

where g_{L}, g_{C} and g_{R} are the distance gain functions corresponding to the segments of the extent of the volumetric source that are represented by the L, C and R virtual sources, respectively.

One possible disadvantage of rendering the volumetric audio source 102 with the rendering configuration 500 with three virtual sources—L, R, and C—as described above is that as the listener 104 closely approaches the audio source 102, the center virtual source C may become too spatially dominant. In other words, the sound image may be dominated too much by the virtual source C such that the audio source 102 is spatially perceived more point-like than would be expected from a real volumetric source of that size.

Using a common distance gain correction function for all virtual sources does not solve the problem discussed above because, in such scenario, the distance gain correction gains of all virtual sources are the same.

Accordingly, in some embodiments of this disclosure, separate distance gain corrections are applied for each virtual source (C, L, and R), thereby remedying the above discussed undesired spatial artifact of the three-virtual-source configuration 500 while at the same time realizing the correct distance gain function for the volumetric audio source as a whole.

As described above, in the three-virtual-sources configuration 500, in some embodiments, a distance gain function for each virtual source C, L, and R may be set to be a target distance gain function of the audio source 102 (i.e., gₙ(rₙ)=g_{target}(rₙ)).

In such embodiments, if the distance between the listener 104 and the audio element 102 is much larger than the size of the extent of the audio element (as illustrated in FIG. 3A), and the source gains sₙ for the three virtual sources are equal, the single common distance gain correction value C(r_{ref}) becomes 1/\sqrt{3}, as shown in the equation (21).

On the other hand, if the distance between the listener 104 and the audio element 102 is much smaller than the size of the extent of the audio element (as illustrated in FIG. 3B), the single common distance gain correction value C(r_{ref}) becomes 1 (if the reference point is the point on the extent that is closest to the listener position 180), as shown in the equation (22).

In some embodiments, instead of using a single distance gain correction function for all three virtual sources, different distance gain correction functions may be used for different virtual sources. For example, the distance gain correction function Cc for the virtual source C may be set to be 1/\sqrt{3} (i.e., the minimum value of the single gain correction) while a common distance gain correction C_{LR} may be applied for the virtual sources L and R. In such embodiments, the equation (6) becomes:

$$C ( {r}_{C} ) = \frac{{g}_{target} ( {r}_{C} )}{\sqrt{{s}_{L}^{2} ( {r}_{L} ) {g}_{L}^{2} ( {r}_{L} ) + {s}_{C}^{2} ( {r}_{C} ) {g}_{C}^{2} ( {r}_{C} ) + {s}_{R}^{2} ( {r}_{R} ) {g}_{R}^{2} ( {r}_{R} )}} , \qquad ( 23 )$$

or, with r_{C}=r_{ref}:

$${C}_{C} = \frac{1}{\sqrt{3}} , \qquad ( 24 )$$

$${C}_{LR} = \sqrt{\frac{2}{3}} ( \frac{{g}_{target} ( {r}_{C} )}{\sqrt{{g}_{target}^{2} ( {r}_{L} ) + {g}_{target}^{2} ( {r}_{R} )}} ) .$$

According to the equation (24), the distance gain correction functions for each of the virtual sources C, L, and R become the same when the listener is far away from the audio source while the relative gain of each of the virtual sources L and R is increased as the listener moves closer towards the audio source (i.e., closer to the center source).

Similar equations to equations (23) and (24) can be derived from the equation (6) for the case where the source gains sₙ are not equal for all three virtual sources.

Thus, while realizing the correct overall distance gain function for the volumetric audio source 102, this embodiment also allows resulting in a slight rebalancing of the energy between the center virtual source C and the left-and right virtual sources L and R in a way that counteracts the “spatial capture” effect of the center virtual source C described above.

### Correlated Sources

In most of the discussion starting from equation (5) above, it was assumed that the signals output by the N virtual sources are uncorrelated. While this may in many applications be a reasonable assumption, there are also applications where the signals have some amount of correlation.

This may for example be the case in applications where the signals for all or some of the N virtual sources are derived from the same input signal(s), for example by means of a process involving panning, upmixing, downmixing, or general matrixing or mapping operations carried out on the input signals corresponding to audio source 102 in order to derive the signals for the virtual sources. In the case of multiple input signals for the audio source 102, these input signals may also have some amount of correlation between them.

In such cases, the general objective equation (4) applies and can be used to derive the distance gain correction functions. Also in this case, a solution with a single common distance gain correction can be derived and is given by equation (8a).

At this point it is important to realize that all variables in equations (4) and (8a), including the distance gain correction functions cₙ and C(r_{ref}), may be frequency-dependent, which in general complicates matters especially when the virtual sources are correlated.

A special case is when the virtual sources are all fully correlated (i.e., coherent), i.e.:

$${θ}_{n} ( {r}_{n} ) = θ ( {r}_{n} ) , ∀ n$$

in which case equation 8a becomes:

$$C ( {r}_{ref} ) = \frac{{g}_{target} ( {r}_{ref} )}{\vert {\sum }_{n = 1}^{N} {s}_{n} ( {r}_{n} ) {g}_{n} ( {r}_{n} ) θ ( {r}_{n} ) \vert} . \qquad ( 25 )$$

The common phase function θ(rₙ) accounts for the phase differences between the rendered signals of the virtual sources due to their different distances rₙ to the listening positioning.

In the far-field (r_{ref}>>size of the extent), all distances become essentially equal, and so the phase terms θ(rₙ) are all equal. Since the phase term has a magnitude of 1, it drops out of the equation, and it follows that at large distances the distance gain correction converges to:

$$C ( {r}_{ref} ) = \frac{{g}_{target} ( {r}_{ref} )}{\vert {\sum }_{n = 1}^{N} {s}_{n} ( {r}_{ref} ) {g}_{n} ( {r}_{ref} ) \vert} . \qquad ( 26 )$$

If additionally all virtual sources have the same distance gain function g_{common}:

$$C ( {r}_{ref} ) = \frac{1}{\vert {\sum }_{n = 1}^{N} {s}_{n} ( {r}_{ref} ) \vert} \times \frac{{g}_{target} ( {r}_{ref} )}{{g}_{common} ( {r}_{ref} )} . \qquad ( 27 )$$

From this we find that in the special case where the distance gain function of the virtual sources is the same as the target distance gain function, the far-field distance gain correction becomes:

$$C ( {r}_{ref} ) = \frac{1}{\vert {\sum }_{n = 1}^{N} {s}_{n} ( {r}_{ref} ) \vert} . \qquad ( 28 )$$

If in addition all N source gains are equal to one, then we obtain:

$$C ( {r}_{ref} ) = \frac{1}{N} . \qquad ( 29 )$$

The above equations can be compared to the corresponding equations for uncorrelated virtual sources, equations (8), (9) and (15).

Other embodiments and concepts that have been described above for uncorrelated virtual sources can also be applied in the case of coherent sources with appropriate modifications to the various equations.

In many applications, the signals output by the N virtual sources will neither all be totally uncorrelated, nor fully coherent with respect to each other. Instead, the N virtual sources may be partially correlated. As already mentioned, these correlations may be due to the processing that is used to derive the signals for the virtual sources from the input signals of the audio source 102, correlations between the input signals of the audio source 102, or a combination thereof.

In principle, the correct distance gain correction for such cases is given by equation (8a). However, a direct application of this equation requires the phase functions θₙ(rₙ) for the N virtual sources, which may not be easy to obtain as they depend on the complete processing used to derive the virtual source signals (which may include stochastic processes like decorrelation), as well as the properties of the input signals of the audio source 102. So, a direct application of equation (8a) may not be practical or feasible.

Instead, the distance gain correction for partially correlated virtual sources may be derived from a linear combination of the solutions for the extreme cases of totally uncorrelated virtual sources and fully coherent virtual sources as described above, where the combination may be controlled by a single (possibly frequency- and/or distance-dependent) correlation control parameter R1 that is representative for the overall correlation between the virtual sources. For example, the correlation control parameter R1 may represent an average correlation value for the rendering configuration with N virtual sources. For example, it may represent an average of the cross-correlations of all pairs of virtual sources in the rendering configuration, or it may be derived using other stochastic processing techniques known to the skilled person, e.g., using a covariance matrix for the virtual source signals.

The value of the correlation control parameter R1 may correspond directly to the actual correlations between the virtual sources (e.g., it may be equal to the average correlation), in which case it may have a value between 0 and 1, or it may be derived therefrom using some suitable mapping function.

Specifically, the distance gain correction may be derived from a linear combination of equations (8) and (25):

$$C ( {r}_{ref} ) = R 1 * {C}_{coherent} ( {r}_{ref} ) + ( 1 - R 1 ) * {C}_{uncorrelated} ( {r}_{ref} ) , \qquad ( 30 a )$$

or, equivalently:

$$C ( {r}_{ref} ) = {C}_{uncorrelated} ( {r}_{ref} ) + R 1 * ( {C}_{coherent} ( {r}_{ref} ) - {C}_{uncorrelated} ( {r}_{ref} ) ) , \qquad ( 30 b )$$

where C_{uncorrelated} and C_{coherent} are the distance gain corrections for uncorrelated and coherent virtual sources according to equations (8) and (25), respectively.

In some embodiments, the overall correlation control parameter R1 that represents the overall correlation between the virtual sources may be separated into a part—R1_processing—that corresponds to the contribution of the processing used for generating the virtual source signals from the input signals of audio source 102 to the overall correlation of the virtual sources, and a part—R1_input—that corresponds to the contribution of the correlations between the input signals of audio source 102 to the overall correlation of the virtual sources. Specifically, the overall correlation control parameter R1 may be the sum of R1_processing and R1_input, i.e.: R1=R1_processing+R1_input, but also other relationships between R1, R1_processing and R1_input are possible.

In one embodiment, the contribution of the processing, R1_processing, may be determined by determining the overall correlation R1 between the virtual sources with fully uncorrelated input signals to the audio source 102 (R1_input=0). Then, the maximum contribution of the input signals, R1_input_max, may be determined by determining the overall correlation R1 between the virtual sources with coherent (i.e., all identical) input signals, and subtracting the value of R1_processing from this. These results can now be interpreted as that R1_processing represents the minimum value R1_min of the overall correlation control parameter R1, i.e., the value with uncorrelated input signals of the audio source 102, while the maximum value of R1 with all identical input signals, R1_max, is given by R1_processing+R1_input_max. The correlation of the input signals of the audio source 102 now determines the value of R1_input between 0 and R1_input_max, and thus the value of R1 between R1_min and R1_max. Specifically, if the overall (e.g., average) correlation between the input signals of the audio source 102 is denoted as rho, then the relationship may be expressed as: R1=R1_min+rho*(R1_max−R1_min). In this case, it follows that R1_processing=R1_min and R1_input=rho*(R1_max−R1_min). Note that all variables in this relationship may have values between 0 and 1.

As an example, consider an audio source 102 that is rendered using 3 virtual sources, and which has a two-channel stereo signal as input. Suppose that when the audio source 102 is fed with an uncorrelated stereo signal, the overall correlation R1 between the three virtual sources is 0.4 (e.g., due to some cross-feeds that are introduced between the three virtual sources as part of the processing for deriving the virtual source signals from the input signals). Thus, here R1_processing (i.e., R1_min)=0.4. Further, suppose that with a coherent stereo signal (i.e., equal left and right signals) as input the overall correlation R1 is 1 (i.e., all virtual sources output the same signal, except for possible scalar gain differences). Then, in the embodiment described above, the relationship between the overall correlation R1 and the correlation rho of the stereo input signal would be: R1=0.4+(1−0.4)*rho=0.4+0.6*rho.

As another example, consider another audio source that is rendered using the same virtual source layout as the previous example, but now with identical signals being fed to all three virtual sources, regardless of the correlation of the stereo input signal of the audio source 102 (e.g., because each virtual source is fed the sum of the two channels of the input signal). In that case, R1_min=R1_processing=1, and so R1=1 independent of the correlation rho of the stereo input signal (and, consequently, the contribution of the correlation of the input signals R1_input=0, regardless of the actual correlation rho of the stereo input signal.) As a final example, consider another audio source that has N virtual sources and an N-channel input signal, with a direct and exclusive mapping between the N input signals and N virtual sources. In this case, R1_min=R1_processing=0, and R1_max=1. So, in this case R1=R1_input=rho.

In the above embodiment, a linear relationship has been assumed between rho and R1 for simplicity. However, in some embodiments, other relationships may be used, such that R1=R1_min+f(rho), where f(rho) is a function that varies between 0 and (R_max−R_min) for values of rho between 0 and 1. In other embodiments, the relationship may be R1=f(rho), where f(rho) is now a function that varies between R_min and R_max for values of rho between 0 and 1.

In some applications, the rendering of the audio source 102 through the virtual sources may be done without taking the propagation delays and relative phases of the virtual sources due to their different distances to the listening position into account. In rendering with real loudspeakers, this is not possible, since the propagation delays and phase differences are introduced physically, but in headphone rendering in an XR system this is easily implemented. A reason for doing this may be that it significantly simplifies the real-time rendering pipeline.

In such cases, the phase functions θₙ in the general equation (8a) represent only the phase relations between the virtual sources that are due to the correlations of the input signals of the audio source 102 and the correlations due to the processing that is used for deriving the virtual source signals from the input signals.

Also, in such cases, the phase function θ(rₙ) in the equation (25) for coherent virtual sources is a constant, and the distance gain correction becomes equal to the far-field equation (26) at all distances. For uncorrelated virtual sources, the solution is still given by equation (8), so that for arbitrary correlations between the virtual sources the solution may now be constructed as a linear combination of equations (8) and (26) according to equation (30a) or (30b), where C_{coherent} now is the distance gain correction for coherent sources according to equation (26) instead of (25).

Alternatively, the equations (8) and (26) for uncorrelated and coherent virtual sources may be combined as follows:

$$C ( {r}_{ref} ) = \frac{{g}_{target} ( {r}_{ref} )}{\sqrt[R 2]{{\sum }_{n = 1}^{N} {( {s}_{n} ( {r}_{n} ) {g}_{n} ( {r}_{n} ) )}^{R 2}}} , \qquad ( 31 )$$

where the overall amount of correlation between the virtual sources is controlled by a correlation control parameter R2 which has a value between 1 (for coherent virtual sources) and 2 (for uncorrelated virtual sources). While the correlation control parameter R2 has the same general purpose as the correlation control parameter R1 in equations (30a) and (30b) (i.e., controlling the position in the solution space between coherent and uncorrelated virtual sources), it does so in a different, non-linear way. In other words, the mapping from the actual correlations between the virtual sources to the correlation control parameter is different for R1 and R2. Specifically, the relationship between R1 and R2 may be given by: R2=2−(R1)^{x}, with x>0, e.g., R2=2−R1, R2=2−\sqrt{R1} or R2=2−R1².

### Multi-Channel Input Signals for the Audio Source 102

Up to this point, the model for the distance gain correction has essentially been described based on the signals that are output by the virtual loudspeakers. However, as mentioned before, each of these virtual loudspeaker signals may be generated from a set of input signals corresponding to the audio source 102 (e.g., a stereo or multi-channel signal), or from an intermediate set of signals derived from those input signals.

Although the models described above (specifically, equation (8a)) correctly describe those multi-channel input signal scenarios as well in principle, it may in practice be hard to derive explicit expressions for the source gains sₙ and phase terms θₙ in the general case.

In some use cases with a multi-channel input signal for the audio source 102, a solution for the distance gain correction may be derived as a combination of solutions for the individual input channels. Essentially, equations 1-3 for the rendered signal at the listener position can then be interpreted as describing the signal level at the listening position due to a single input channel i, and the total signal level at the listening position then follows from:

$${{p}_{total}^{2} = \vert {\sum }_{i = 1}^{M} {\sum }_{n = 1}^{N} {p}_{n , i} ( {r}_{n} ) \vert}^{2}$$

where i=1 . . . M indicates a specific input channel, M is the number of input channels, and p_{n,i} is the pressure at the listening position due to the n-th virtual source and i-th input channel.

In some applications, it may be possible to derive an explicit solution for the distance gain correction from the general equation (8a) that directly captures the correlations between the virtual sources in an explicit form. Examples of this were already provided above for the simple cases of fully uncorrelated and fully coherent virtual sources, both of which cases are essentially independent of the number and properties of the input signals of the audio source 102. But also in some more complex cases, with non-trivial relationships between the virtual sources and/or a multi-channel input signal of the audio source 102, an explicit solution for the distance gain correction can sometimes be derived.

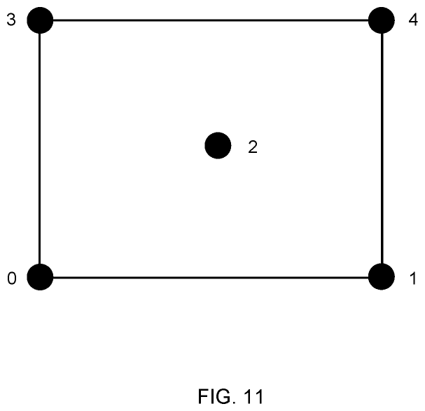

As an example, consider an audio source that is rendered using five virtual sources labeled 0-4, arranged as shown in FIG. 11. Suppose that the signals for the virtual sources are generated such that the signals for virtual sources 0 and 3 are derived from the left channel of a stereo input signal, the signals for virtual sources 1 and 4 are derived from the right channel of the stereo input signal, and the signal for virtual source 2 is derived from w*(left+right), where w is a weight, and that the processing to derive the signal for virtual source i is captured by the corresponding source gain sᵢ(rᵢ). The weight w may be fixed, e.g., w=0.5 or w=0.5*sqrt(2), or it may be variable, e.g., it may depend on the cross-correlation between the left and right input signals.

In this case, if the left and right channels of the stereo input signal are uncorrelated then this rendering configuration can be considered as a combination of two uncorrelated source clusters (left and right), each consisting of three coherent sub-sources (0, 3 and 2 for the left source cluster, and 1, 4 and 2 for the right source cluster). An explicit solution for the distance gain correction can then be derived from equation (8a) as;

$$C ( {r}_{ref} ) = \frac{{g}_{target} ( {r}_{r e f} )}{\sqrt{{( {s}_{0} ( {r}_{0} ) g ( {r}_{0} ) + {s}_{3} ( {r}_{3} ) g ( {r}_{3} ) + w * {s}_{2} ( {r}_{2} ) g ( {r}_{2} ) )}^{2} + {( {s}_{1} ( {r}_{1} ) g ( {r}_{1} ) + {s}_{4} ( {r}_{4} ) g ( {r}_{4} ) + w * {s}_{2} ( {r}_{2} ) g ( {r}_{2} ) )}^{2}}} , \qquad ( 32 )$$

where it has been assumed that all virtual sources have the same distance gain function g.

Similarly, if the left and right channels of the stereo input signal are identical, the explicit solution that can be derived from equation (8a) is (see also equation (26)):

$$C ( {r}_{r e f} ) = \frac{{g}_{target} ( {r}_{r e f} )}{{\sum }_{i = 0}^{4} {s}_{i} ( {r}_{i} ) g ( {r}_{i} )} , \qquad ( 33 )$$

where it has been assumed that in the rendering of the virtual sources, their phase differences due to their different distances to the listening position are not taken into account, as explained earlier (or that these phase differences are insignificant due to the listening distance being large relative to the distances between the virtual loudspeakers).

Now, the solution for arbitrary correlation of the stereo input signal can be constructed as a linear combination of equations (32) and (33), similar to equation (30a) (or (30b)), i.e.:

$$C ( {r}_{r e f} ) = R 3 * {C}_{st\_coherent} ( {r}_{r e f} ) + ( 1 - R 3 ) * {C}_{st\_uncorrelated} ( {r}_{r e f} ) , \qquad ( 34 )$$

where C_{st_uncorrelated} is the distance gain correction with uncorrelated stereo input signal according to equation (32), C_{st_coherent} is the distance gain correction with coherent stereo input signal according to equation (33), and R3 is the correlation control parameter that selects the solution from the solution space between uncorrelated stereo input signal and coherent stereo input signal. R3 may be equal to the cross-correlation rho between the left and right channels of the stereo input signal. Note that the difference between the equations (30a) and (34) is that while equation (30a) gives the solution as a linear combination of the solutions for uncorrelated virtual sources and coherent virtual sources, equation (34) gives the solution as a linear combination of the solutions with uncorrelated input signals and coherent input signals of the audio source 102, both of which solutions already take the correlations between the virtual sources due to the processing into account. Hence, the roles of R1 and R3 in equations (30a) and (34), respectively, are not the same, with R3 in equation (34) being more directly related to the correlations of the input signals of audio source 102, and R1 in equation (30a) being related to the overall correlations between the virtual sources (including the correlations due to the processing).

Looking at the renderer output for the specific configuration with five virtual sources and stereo input signal as described above as function of listening distance and for various values of the cross-correlation parameter rho of the stereo input signal, it was observed that in this case all distance gain curves are identical in shape with simply a gain offset that depends on the cross-correlation parameter rho.

So, in some embodiments the distance gain correction for arbitrary correlation of the input signals of audio source 102 may be obtained from multiplication of the distance gain correction for an uncorrelated input signal (or, alternatively, the distance gain correction for a coherent input signal) with a factor that is a function of the correlation of the input signals, i.e., as:

$$C ( {r}_{r e f} ) = f ( r h o ) * {C}_{input\_uncorrelated} ( {r}_{r e f} ) , \qquad ( 35 )$$

where f(rho) is a function of the input signals correlation parameter rho, and C_{input_uncorrelated} is the distance gain correction for uncorrelated input signals.

For the specific configuration with five virtual sources and stereo input signal, it was found that:

$$C ( {r}_{r e f} ) = ( \frac{1}{\sqrt{1 + r h o}} ) * {C}_{input\_uncorrelated} ( {r}_{r e f} ) , \qquad ( 36 )$$

where C_{st_uncorrelated} is according to equation (32).

Note that while equations (34), (35) and (36) were introduced above in the context of the specific example, the equations and/or the concepts behind them may apply more generally to the rendering of audio sources with a stereo or multi-channel input signal. Specifically, the concept of constructing the distance gain correction for arbitrary correlations of the (two or more) input signals as a linear combination of the solutions for uncorrelated input signals and identical input signals (as expressed in equation (34)) is a concept that can be applied to the rendering of any audio source 102 with multiple input signals.

### Carriage of Correlation Control Parameter in the Bitstream, or Local Calculation

Any of the correlation control parameters R1, R1_min, R1_max, R2, R3 and/or the correlation parameter of the input signals rho can be received as metadata (e.g., from a bitstream or file), or can be derived by the renderer itself. Since R1, R1_min, R_max and R2 depend on the rendering algorithm (spatial configuration and processing applied to virtual speakers), a likely scenario may be that R1_min and R1_max are prespecified in the renderer, and the renderer then calculates R1 from the prespecified R1_min and R1_max and the correlation of the input signals, rho. The input signal correlation parameter rho may be received as metadata, either as part of the source metadata or as part of the metadata for a multi-channel signal associated with the source. The input signal correlation parameter rho may be dynamic, i.e., reflecting the correlations of the source input signals at a specific moment in time, or it may be (semi)-static, i.e., representing a time-averaged or representative correlation for (a time segment of) the source input signals.

Instead of being received directly, the input signal correlation parameter rho may be derived from another received parameter. For example, rather than receiving the correlation parameter rho, the renderer may instead receive a “diffuseness” parameter associated with the source and/or with the input signals associated with the source, which may have a straightforward relationship to the correlation parameter rho. For example, the diffuseness parameter may essentially be the complement of the input correlation parameter rho, i.e., the relationship may be: rho=1−diffuseness. In other cases, the alternative received parameter (e.g., the diffuseness parameter) may more directly correspond to the overall correlation control parameter R1, e.g., if it describes the spatial diffuseness of the source as such. In such a case, there may be a straightforward relationship between the received parameter and R1, e.g., R1=1−diffuseness. From the above, it should be clear that any of the equations provided in this disclosure can easily be rewritten in terms of any such alternative parameter that may be received or available to the renderer instead of the specific parameters used in the equations, and that any implementation using any such alternative parameters and/or equations is covered by this disclosure.

Alternatively, the renderer itself could determine the correlation parameter rho from the received source input signals using correlation analysis algorithms known to the skilled person.

### Normalization of the Distance Gain Correction to Exclude Compensation for Overall Level Increase Due to Using N Virtual Sources

Looking at the far-field approximations of the equations derived for the various embodiments with uncorrelated virtual sources above (i.e. the equations (9), (12), (15), (18), and (21) for listening positions at a large distance to the audio source 102), a common factor appears in all equations, namely:

$$\frac{1}{\sqrt{{\sum }_{n = 1}^{N} {s}_{n}^{2} ( {r}_{r e f} )}} . \qquad ( 37 )$$

The corresponding factor for coherent sources (see equations (26) and (27)) is:

$$\frac{1}{\vert {\sum }_{n = 1}^{N} {s}_{n} ( {r}_{r e f} ) \vert} . \qquad ( 38 )$$

For use cases where the source gains sₙ for all virtual sources are equal to one, these factors simplify to:

$$\frac{1}{\sqrt{N}} , and \frac{1}{N} ,$$

for uncorrelated and coherent virtual sources, respectively.

In the far-field, these factors in the distance gain correction represent a compensation for the level difference that results from using the N virtual sources to render the audio source 102, relative to the level of a single virtual source with unity source gain and distance gain function equal to the target distance gain function.

Looking more closely, the denominator of equation (37) for uncorrelated sources represents the total power represented by the N source gains of the N-virtual speaker rendering configuration, while the denominator of equation (38) for coherent sources represents the total gain represented by the N source gains.

It might be argued that this relative level difference effect is more like an overall level offset for the rendering configuration, rather than being part of its distance gain function, and should therefore maybe not appear in the distance gain corrections cₙ that are intended to give the rendering configuration with N virtual sources the same distance gain function as the target distance gain function for the audio source 102.

Indeed, in many applications this compensation for the overall relative level due to using N virtual sources may be taken care of elsewhere in the rendering process, i.e., outside of the dedicated distance gain correction processing, as a standard normalization procedure.

Therefore, in some embodiments, e.g., if this compensation for the overall relative level is done downstream from the distance gain correction processing, the distance gain corrections cₙ for the virtual sources may be normalized to not include the compensation for the overall level increase due to using N virtual sources. The resulting distance gain corrections are then really only affecting the distance gain of the rendering configuration, and nothing else.

Specifically, all equations derived above may be normalized by dividing them by the corresponding N-speaker relative level difference factors given above, i.e. equation (37) for uncorrelated virtual sources, and equation (38) for coherent virtual sources.

Note that in the case of using the target distance gain function as the distance gain function for the virtual sources, the normalized distance gain correction at large distances converges to 1 for both uncorrelated and coherent virtual sources (see equations (15) and (27)).

As an illustrative use case, some example renderer may normalize the total power that is radiated by the virtual sources, such that an equal amount of power is radiated independent of the number of virtual sources N that is used. This total power is at any instant given by:

$$total power = {\sum }_{n = 1}^{N} {s}_{n}^{2} ( {r}_{n} ) , \qquad ( 39 )$$

where the number of virtual sources N may be dynamic (e.g., it may be a function of the listening distance r_{ref}). So, in some embodiments, e.g., if the renderer applies the normalization of the radiated power according to equation (39) as part of its rendering process somewhere downstream of the distance gain correction processing, the distance gain correction may be compensated for this by multiplying it with the square root of equation (39), as expressed by equation (37) for the far-field (where rₙ is equal to r_{ref}). Similarly, for an example renderer that normalizes the total gain of the virtual sources downstream of the distance gain correction processing, this leads to the compensation of the distance gain correction as expressed by equation (38).

As mentioned earlier, essentially all parameters that appear in the equations provided in this disclosure may be frequency-dependent, so that the resulting distance gain correction functions are in general filters rather than broadband gains. Also all correlation-related parameters, including the correlation control parameters R1, R2 and R3, the input signal correlation parameter rho, etc., may be frequency dependent. As a result, for example the mixture of the solutions for uncorrelated and coherent virtual sources as expressed in equation 30a, or the mixture of solutions for uncorrelated and coherent source input signals as expressed in equation (34), may be frequency-dependent.

In the above, methods have been described that allow the distance gain correction to be adapted to (static or dynamic) properties of the input signals of audio source 102, specifically the number of input signals, relative amplitudes and phases of the input signals, and the correlations between them, such that the target distance gain for the audio source 102 is always realized, even if the properties of the input signals of audio source 102 are (dynamically) changed. In many use cases this may indeed be a desirable result.

However, in many other use cases such an adaptive distance gain correction that accounts for (changes in) the properties of the actual input signals of audio source 102 may not be practical or even desirable, as will be discussed now.

A practical issue is that in order to do a distance gain correction that takes the properties of the actual input signals into account, these properties need to be known to the renderer, which is often not the case.

Furthermore, in many applications it may actually be desirable that changes in (some of) the properties of the input signals of audio source 102 also lead to corresponding changes in the rendered audio source's distance gain function that are consistent with those changes in the input signal properties. E.g., suppose that audio source 102 is a planar source that is rendered using five virtual sources, as shown in FIG. 11. Now, suppose that the input signals of the audio source 102 are such that the five resulting virtual source signals are essentially uncorrelated, then the audio source 102 represents a spatially diffuse source, which (from physics) is expected to have a certain distance gain behavior. Now suppose that the input signals to the audio source 102 are changed such that the five resulting virtual source signals are essentially coherent. Now, the audio source 102 represents a spatially coherent source, which (from physics) is also expected to have a certain distance gain behavior that is different from a spatially diffuse source. So, in this case it would only be natural if these physically expected different distance gain behaviors corresponding to different properties of the input signals of audio source 102 are reflected in the resulting distance gain behavior of the rendered audio source after the distance gain correction.

Therefore, in some embodiments the distance gain correction is calculated assuming certain reference properties for the input signals of audio source 102 or for the virtual source signals. E.g., the calculation of the distance gain correction may be based on an assumption of mutually uncorrelated virtual sources (leading to equation (8)), or an assumption of an uncorrelated, equal amplitude stereo input signal (e.g., equation (32)), regardless of the properties of the actual input signals of the audio source 102. In many cases this may provide a satisfactory result, where the distance gain correction results in a perfect match to the target distance gain when the actual signal properties match the reference properties assumed in the distance gain correction calculation, while the deviation from the target distance gain is a natural one for signals having properties that are different from the reference properties.

If the target distance gain was derived from a model that uses certain assumptions regarding the properties of the audio source 102, then the calculation of the distance gain correction may be based on those same, or similar, assumptions. For example, if the target distance gain model is based on an (implicit) assumption that the audio source 102 is a spatially diffuse source, then the distance gain correction calculation may be based on a corresponding assumption that the virtual sources used for rendering the audio source 102 are all mutually uncorrelated, leading to the model of equation (8).

In other embodiments, the distance gain correction calculation may be based on one of several preset models, where a specific preset model is selected based on the actual properties of the input signals of audio source 102. E.g., in an example renderer that allows various multi-channel input signal layouts, e.g. 2-channel horizontal stereo, 3-channel horizontal stereo, or a vertical planar regular grid layout (e.g., a 3×3 grid), the distance gain correction calculation may, upon detection of a specific one of these input signal layouts, be based on one of the available preset models. E.g., in case of a horizontal-only input signal layout (e.g., 2- or 3-channel stereo), the distance gain correction calculation may be based on a model that is based on an uncorrelated 2-channel stereo input signal assumption, while in case of an input signal layout that contains vertical channels the calculation may be based on an assumption of mutually uncorrelated virtual sources.

In a more advanced variation of this embodiment, the selection of a specific preset model for the distance gain correction may take into account further properties of the input signals, e.g., their relative levels (e.g., only taking channels into account that have a sufficiently significant signal level, e.g., treating a multi-channel input signal as a horizontal-only input signal layout if any vertical channels that are present have a very low level relative to the horizontal channels).

In a further embodiment, the renderer may receive metadata accompanying the audio source 102 (or the input signals corresponding to the audio source 102) that instructs the renderer to use a specific one of available distance gain correction models when rendering the audio source 102. This way, a content creator or authoring tool can control the distance gain correction behavior for the source.

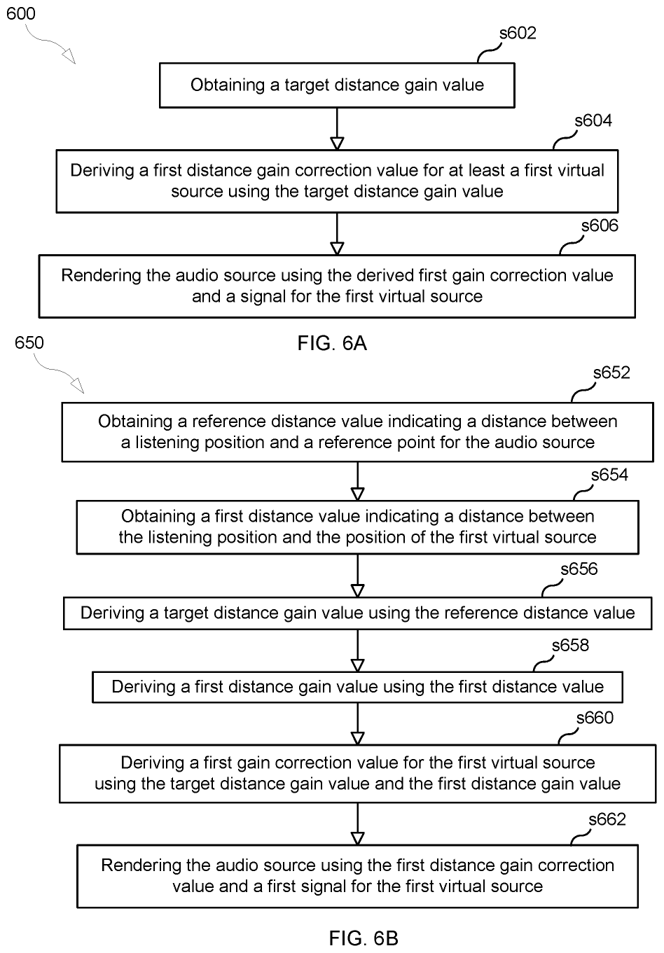

FIG. 6A shows a process 600 for rendering the audio source 102 according to some embodiments. The audio source 102 may be rendered using a plurality of virtual sources that includes a first virtual source. Process 600 may begin with step s602. Step s602 comprises obtaining a target distance gain value, wherein the target distance gain value was derived using a target distance gain function for the audio source and a reference distance value indicating a distance between a listening position and a reference point for the audio source. Step s604 comprises deriving a first distance gain correction value for at least the first virtual source using the target distance gain value. Step s606 comprises rendering the audio source using the derived first distance gain correction value and a signal for the first virtual source.

In some embodiments, process 600 further comprises obtaining a first source distance value indicating a distance between a position of the first virtual source and the listening position, wherein the first distance gain correction value for the first virtual source is derived further using the first source distance value.

In some embodiments, process 600 further comprises obtaining a distance gain value, wherein the distance gain value was derived using a source distance gain function for the first virtual source, wherein the first distance gain correction value for the first virtual source is derived further using the distance gain value.

In some embodiments, the target distance gain value was derived by evaluating the target distance gain function at the reference distance value.

In some embodiments, the audio source is rendered using at least the first virtual source and a second virtual source, the audio source is rendered using the derived first distance gain correction value for the first virtual source and using a second distance gain correction value for the second virtual source, and the second distance gain correction value is the same as the derived first distance gain correction value.

In some embodiments, the audio source is rendered using at least the first virtual source and a second virtual source, the audio source is rendered using the derived first distance gain correction value for the first virtual source and using a second distance gain correction value for the second virtual source, and the second distance gain correction value for the second virtual source is derived using the source distance gain function.

In some embodiments, the audio source is rendered using N virtual sources, where N is a positive integer, each of the N virtual sources is associated with a source distance gain value obtained by evaluating one of one or more source distance gain functions at each source distance value indicating a distance between the listening position and a location of each virtual source, and the first distance gain correction value is calculated using a combined value of the source distance gain values.

In some embodiments, the source distance gain value associated with each of the N virtual sources is obtained by evaluating the same source distance gain function.

In some embodiments, the first distance gain correction value is calculated based on a ratio of the target distance gain value and the combined value of the source distance gain values.

In some embodiments, the combined value of the source distance gain values is determined based on a sum of squares of the source distance gain values or a sum of the source distance gain values.

In some embodiments, the sum of squares of the source distance gain values is a weighted sum of squares of the source distance gain values, or the sum of the source distance gain values is a weighted sum of the source distance gain values.

In some embodiments, the first distance gain correction value is equal to the target distance gain value divided by either the combined value or a square root of the combined value.

In some embodiments, the source distance gain function for the first virtual source is proportional to A/r₁, A is a constant, and r₁ is the first source distance value.

In some embodiments, the source distance gain function for the first virtual source is equal to the target distance gain function for the audio source.

In some embodiments, the source distance gain function is a constant.

In some embodiments, the first distance gain correction value is a common distance gain correction value that is common for all virtual sources used for rendering the audio source.

In some embodiments, the common distance gain correction value is calculated based on:

$$\frac{{g}_{target} ( {r}_{r e f} )}{\sqrt{{\sum }_{n = 1}^{N} {s}_{n}^{2} ( {r}_{n} ) {g}_{n}^{2} ( {r}_{n} )}} ,$$

where r_{ref} is the reference distance value, g_{target}(r_{ref}) is the target distance gain value, N is the number of virtual sources used for rendering the audio source, rₙ is a distance between the listening position and n-th virtual source, sₙ(rₙ) is a source gain value for the n-th virtual source at rₙ, and gₙ(rₙ) is a value of a distance gain function for the n-th virtual source at rₙ.

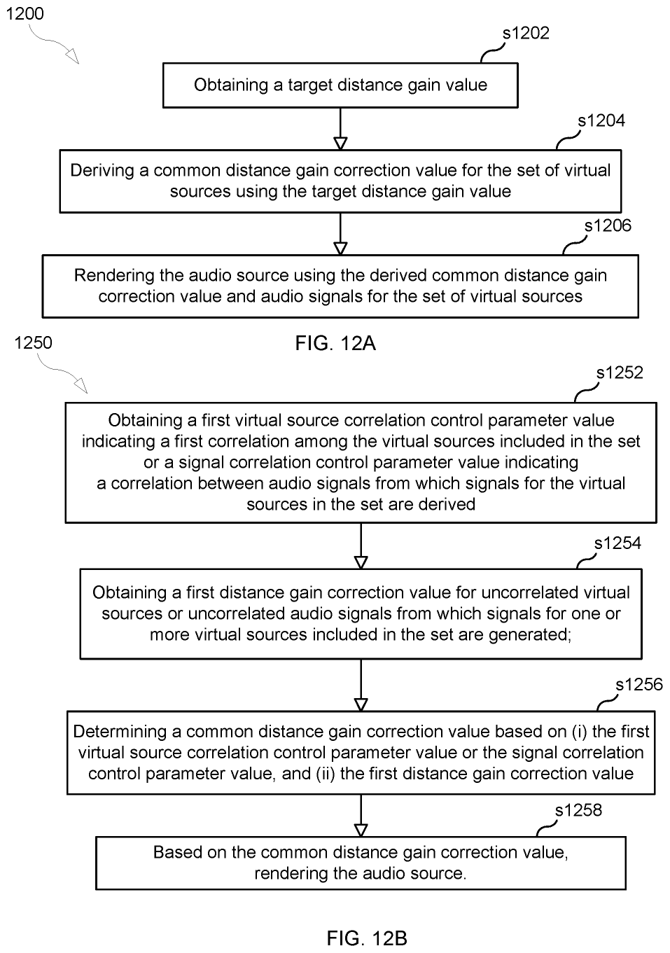

FIG. 12A shows a process 1200 for rendering the audio source 102 using a multi-channel input signal and a set of virtual sources. Process 1200 may begin with step s1202. Step s1202 comprises obtaining a target distance gain value. Step s1204 comprises deriving a common distance gain correction value for the set of virtual sources using the target distance gain value. Step s1206 comprises rendering the audio source using the derived common distance gain correction value and audio signals for the set of virtual sources, wherein the set of virtual sources comprises a first cluster of one or more virtual sources associated with a first channel of the multi-channel input signal and a second cluster of one or more virtual sources associated with a second channel of the multi-channel input signal, the first cluster and the second cluster share at least one shared virtual source, an audio signal for said at least one shared virtual source is derived based on a weight and a sum of signals associated with the first and second channels, and the common distance gain correction value is calculated based at least on the weight.

In some embodiments, the first cluster of virtual sources comprises a first virtual source, a second virtual source, and a third virtual source, the second cluster of virtual sources comprises the second virtual source, a fourth virtual source, and a fifth virtual source, and the common distance gain correction value is calculated as:

$$C ( {r}_{ref} ) = \frac{{g}_{target} ( {r}_{r e f} )}{\sqrt{{( {s}_{0} ( {r}_{0} ) g ( {r}_{0} ) + {s}_{3} ( {r}_{3} ) g ( {r}_{3} ) + w * {s}_{2} ( {r}_{2} ) g ( {r}_{2} ) )}^{2} + {( {s}_{1} ( {r}_{1} ) g ( {r}_{1} ) + {s}_{4} ( {r}_{4} ) g ( {r}_{4} ) + w * {s}_{2} ( {r}_{2} ) g ( {r}_{2} ) )}^{2}}} ,$$

where r_{ref} is a reference distance value (r_{ref}) indicating a distance between a listening position and a reference point for the audio source, C(r_{ref}) is the common distance gain correction value, g_{target}(r_{ref}) is the target distance gain value, r₀ is a distance between the listening position and the first virtual source, s₀(r₀) is a source gain value for the first virtual source at r₀, r₁ is a distance between the listening position and the second virtual source, s₁(r₁) is a source gain value for the second virtual source at r₁, r₂ is a distance between the listening position and the third virtual source, s₂(r₂) is a source gain value for the third virtual source at r₂, r₃ is a distance between the listening position and the fourth virtual source, s₃(r₃) is a source gain value for the fourth virtual source at r₃, r₄ is a distance between the listening position and the fifth virtual source, s₄(r₄) is a source gain value for the fifth virtual source at r₄, g₀(r₀) is a value of a distance gain function for the first virtual source at r₀, g₁(r₁) is a value of a distance gain function for the second virtual source at r₁, g₂(r₂) is a value of a distance gain function for the third virtual source at r₂, g₃(r₃) is a value of a distance gain function for the fourth virtual source at r₃, g₄(r₄) is a value of a distance gain function for the fifth virtual source at r₄, and w is the weight.

FIG. 6B shows a process 650 for rendering an audio source represented by at least a first virtual source and a second virtual source. Process 650 may begin with step s652. Step s652 comprises obtaining a reference distance value indicating a distance between a listening position and a reference point for the audio source. Step s654 comprises obtaining a first distance value indicating a distance between the listening position and the position of the first virtual source. Step s656 comprises deriving a target distance gain value using the reference distance value. Step s658 comprises deriving a first distance gain value using the first distance value. Step s660 comprises deriving a first distance gain correction value for the first virtual source using the target distance gain value and the first distance gain value. Step s662 comprises rendering the audio source using the first distance gain correction value and a first signal for the first virtual source.

In some embodiments, rendering the audio source using the first distance gain correction value (a) and the first signal (s1) for the first virtual source comprises producing a first modified signal (s1′), wherein s1′=a1×s1.

FIG. 12B shows a process 1250 for rendering the audio source 102 using a set of virtual sources. Process 1250 may begin with step s1252. Step s1252 comprise obtaining a first virtual source correlation control parameter value indicating a first correlation among the virtual sources included in the set or a signal correlation control parameter value indicating a correlation between audio signals from which signals for the virtual sources in the set are derived. Step s1254 comprises obtaining a first distance gain correction value for uncorrelated virtual sources or uncorrelated audio signals from which signals for one or more virtual sources included in the set are generated. Step s1256 comprises determining a common distance gain correction value based on (i) the first virtual source correlation control parameter value or the signal correlation control parameter value, and (ii) the first distance gain correction value. Step s1258 comprises, based on the common distance gain correction value, rendering the audio source.

In some embodiments, process 1250 further comprises obtaining a second distance gain correction value for coherent virtual sources or correlated audio signals from which signals for one or more virtual sources included in the set are generated, wherein the common distance gain correction value is determined further based on the second distance gain correction value.

In some embodiments, the common distance gain correction value is calculated based on R*C_{coherent}(r_{ref})+(1−R)*C_{uncorrelated}(r_{ref}), where r_{ref} is a reference distance value indicating a distance between a listening position and a reference point for the audio source, R is the first virtual correlation control parameter value or the signal correlation control parameter value, C_{coherent}(r_{ref}) is the second distance gain correction value, and C_{uncorrelated}(r_{ref}) is the first distance gain correction value.

In some embodiments, the common distance gain correction value is calculated based on f(a)*C_{input_uncorrelated}(r_{ref}), where a is the signal correlation control parameter value, f(a) is a function of the signal correlation control parameter value, r_{ref} is a reference distance value (r_{ref}) indicating a distance between a listening position and a reference point for the audio source, and C_{input_uncorrelated}(r_{ref}) is the first distance gain correction value.

In some embodiments, the first virtual source correlation control parameter value is determined based on a second virtual source correlation control parameter value and a third virtual source correlation control parameter value, the second virtual source correlation control parameter value indicates a second correlation between the virtual sources in the set when the input signals of the audio source are all mutually uncorrelated, and the third virtual source correlation control parameter value indicates a third correlation between the virtual sources in the set when the input signals of the audio source are all identical.

In some embodiments, the first virtual source correlation control parameter value is determined further based on a correlation between input signals from which signals for the virtual sources in the set are derived.

In some embodiments, the first virtual source correlation control parameter value is calculated as: R1=R1_min+rho*(R1_max−R1_min), where R1 is the first virtual source correlation control parameter value, R1_min is the second virtual source correlation control parameter value, R1_max is the third virtual source correlation control parameter value, and rho is the signal correlation control parameter value.

### Example Use Case

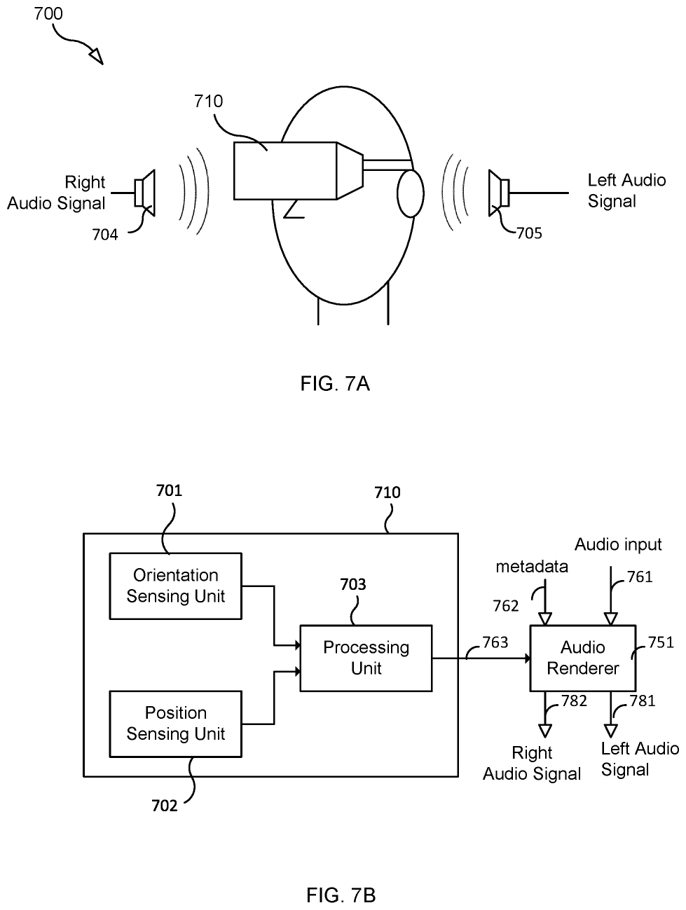

FIG. 7A illustrates an XR system 700 in which the embodiments disclosed herein may be applied. XR system 700 includes speakers 704 and 705 (which may be speakers of headphones worn by the listener) and an XR device 710. In the illustrated XR system 700, XR device 710 has a display and is designed to be worn on the user's head and is commonly referred to as a head-mounted display (HMD).

As shown in FIG. 7B, XR device 710 may comprise an orientation sensing unit 701, a position sensing unit 702, and a processing unit 703 coupled (directly or indirectly) to an audio renderer 751 for producing output audio signals (e.g., a left audio signal 781 for a left speaker and a right audio signal 782 for a right speaker as shown).

Orientation sensing unit 701 is configured to detect a change in the orientation of the listener and provides information regarding the detected change to processing unit 703. In some embodiments, processing unit 703 determines the absolute orientation (in relation to some coordinate system) given the detected change in orientation detected by orientation sensing unit 701. There could also be different systems for determination of orientation and position, e.g., a system using lighthouse trackers (lidar). In one embodiment, orientation sensing unit 701 may determine the absolute orientation (in relation to some coordinate system) given the detected change in orientation. In this case the processing unit 703 may simply multiplex the absolute orientation data from orientation sensing unit 701 and positional data from position sensing unit 702. In some embodiments, orientation sensing unit 701 may comprise one or more accelerometers and/or one or more gyroscopes.

Audio renderer 751 produces the audio output signals based on input audio signals 761, metadata 762 regarding the XR scene the listener is experiencing, and information 763 about the location and orientation of the listener. The metadata 762 for the XR scene may include metadata for each object and audio source included in the XR scene, and the metadata for an object may include information about the dimensions of the object. The metadata 762 may also include control information, such as a reverberation time value, a reverberation level value, and/or an absorption parameter. Audio renderer 751 may be a component of XR device 710 or it may be remote from the XR device 710 (e.g., audio renderer 751, or components thereof, may be implemented in the so called “cloud”).

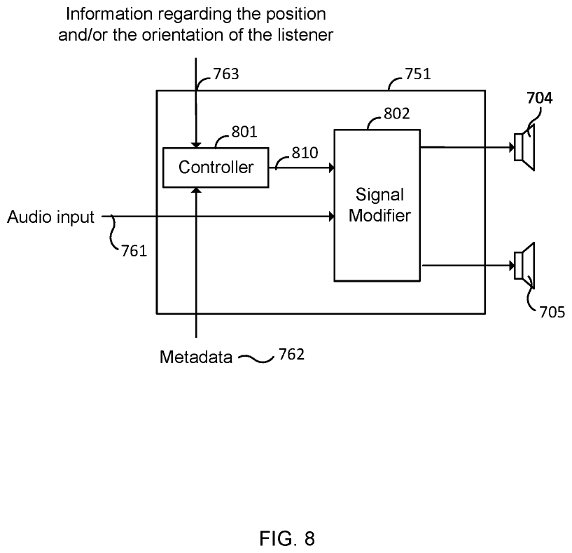

FIG. 8 shows an example implementation of audio renderer 751 for producing sound for the XR scene. Audio renderer 751 includes a controller 801 and a signal modifier 802 for modifying audio signal(s) 761 (e.g., the audio signals of a multi-channel audio element) based on control information 810 from controller 801. Controller 801 may be configured to receive one or more parameters and to trigger modifier 802 to perform modifications on audio signals 761 based on the received parameters (e.g., increasing or decreasing the volume level). The received parameters include information 763 regarding the position and/or orientation of the listener and metadata 762 regarding an audio element in the XR scene (e.g., extent of the audio element) (in some embodiments, controller 801 itself produces some or all of the elements the metadata 762). Using the received parameters, the direction of an audio element with respect to the listener and a distance between the audio element and the listener may be derived. Using the metadata and position/orientation information, controller 801 may calculate one more gain factors (g) (a.k.a., attenuation factors) for an audio element in the XR scene. Detailed explanation as to how the controller 801 calculates the gain factor(s) is provided below. Detailed explanation as to how the controller 801 calculates the gain factor(s) is provided below.

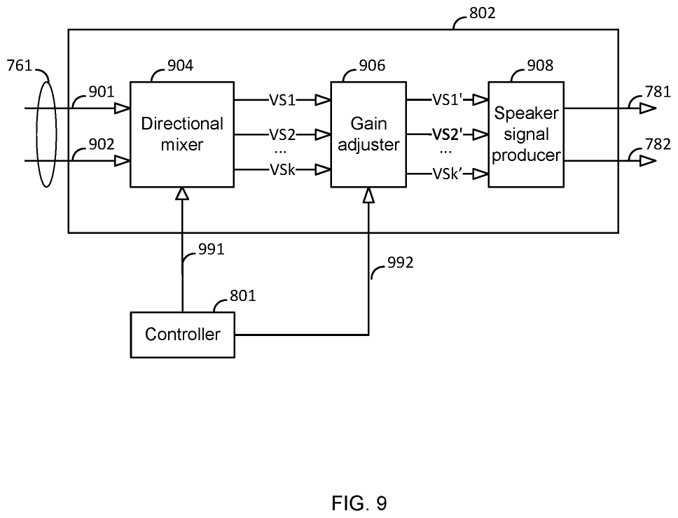

FIG. 9 shows an example implementation of signal modifier 802 according one embodiment. Signal modifier 802 includes a directional mixer 904, a gain adjuster 906, and a speaker signal producer 908.

Directional mixer 904 receives audio input 761, which in this example includes a pair of audio signals 901 and 902 associated with an audio element (e.g., the audio source 102 associated with extent 120), and produces a set of k virtual loudspeaker signals (VS1, VS2, . . . , VSk) based on the audio input and control information 991. In one embodiment, the signal for each virtual loudspeaker can be derived by, for example, the appropriate mixing of the signals that comprise the audio input 761. For example: VS1=α×L+β×R, where L is input audio signal 901, R is input audio signal 902, and α and β are factors that are dependent on, for example, the position of the listener relative to the audio element and the position of the virtual loudspeaker to which VS1 corresponds.

Gain adjuster 906 may adjust the gain of any one or more of the virtual loudspeaker signals VS1, VS2, . . . , VSk (e.g., for the virtual sources 202, 204, and 206) based on control information 992, thereby producing adjusted virtual loudspeaker signals VS1′, VS2′, . . . , VSk′. The control information 992 that the gain adjuster 906 receives from the controller 801 may include distance gain correction values.

The distance gain correction values may be derived from the above described distance gain correction functions each of which is associated with a virtual source. For example, as discussed above, in the configuration 500 shown in FIG. 5, in some scenarios, the common distance gain correction function C(r_{C}) for all virtual sources (a.k.a., loudspeakers) may be expressed as:

$$C ( {r}_{C} ) = \frac{{g}_{target} ( {r}_{C} )}{\sqrt{{( \frac{{s}_{C} ( {r}_{C} )}{{r}_{C}} )}^{2} + {( \frac{{s}_{L} ( {r}_{L} )}{{r}_{L}} )}^{2} + {( \frac{{s}_{R} ( {r}_{R} )}{{r}_{R}} )}^{2}}} .$$

In such case, the controller 801 may calculate the common distance gain correction value for a virtual source by inserting r_{C}, r_{L}, r_{R}, and g_{target}(r_{C}). The controller 801 may determine r_{C}, r_{L}, r_{R}, and g_{target}(r_{C}) based on the metadata and the position/orientation information.

For example, the metadata may include a position of each virtual source and the position/orientation information may include a position of the listener. The controller 801 may determine the distance (r_{C}, r_{L}, r_{R}) between the position of each virtual source and the position of the listener. Here, the common distance gain correction value corresponds to the aforementioned gain factor.

In addition to the distance gain correction values, the control information 992 may also include a distance gain value associated with a virtual source. The distance gain value may be derived from the above described distance gain function. For example, as discussed above, in some embodiment, a distance gain function for a virtual source may be the same as

$$( i . e . , {g}_{n} ( {r}_{n} ) = \frac{1}{{r}_{n}} ) .$$

In such case, the controller 801 may calculate the distance gain value for a virtual source by inserting rₙ.

Upon receiving the control information 992, the gain adjuster 996 may produce adjusted virtual loudspeaker signals VS1′, VS2′, . . . , VSk′ based on the distance gain value(s) (G) and the distance gain correction value(s) (C) included in the control information 992. For example, the adjusted virtual loudspeaker signal VS1′ may be equal to C×G×VS1.

In some embodiments, instead of the controller 801 providing the distance gain correction value and the distance gain value separately, the controller 801 may calculate the overall gain factor for a virtual source based on the distance gain correction value and the distance gain value for the virtual source, and provide the calculated overall gain factor for the virtual source to the gain adjuster 906. For example, the controller 801 may calculate C×G (the overall gain factor for the virtual source) and provide to the gain adjuster 906 the control information 992 including the overall gain factor.

Even though FIG. 9 shows that the controller 801, the directional mixer 904, the gain adjuster 906, and the speaker signal producer 908 are separate entities, in some embodiments, some or all of them may be implemented in a single entity. For example, there may be one entity providing all functions of the controller 801, the directional mixer 904, the gain adjuster 906, and the speaker signal producer 908. In another example, there may be two entities or three entities providing all functions of the controller 801, the directional mixer 904, the gain adjuster 906, and the speaker signal producer 908.

Using the adjusted virtual loudspeaker signals VS1′, VS2′, . . . , VSk′, speaker signal producer 908 produces output signals (e.g., output signal 781 and output signal 782) for driving speakers (e.g., headphone speakers or other speakers). In one embodiment where the speakers are headphone speakers, speaker signal producer 908 may perform conventional binaural rendering to produce the output signals. In embodiments where the speakers are not headphone speakers, speaker signal producer 908 may perform conventional loudspeaker panning to produce the output signals.

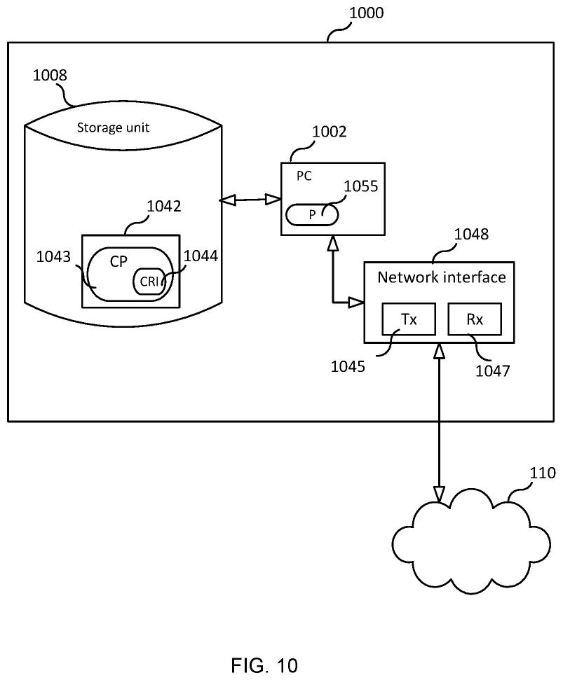

FIG. 10 is a block diagram of an audio rendering apparatus 1000, according to some embodiments, for performing the methods disclosed herein (e.g., audio renderer 751 may be implemented using audio rendering apparatus 1000). As shown in FIG. 10, audio rendering apparatus 1000 may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1000 may be a distributed computing apparatus); at least one network interface 1048 comprising a transmitter (Tx) 1045 and a receiver (Rx) 1047 for enabling apparatus 1000 to transmit data to and receive data from other nodes connected to a network 110 (e.g., an Internet Protocol (IP) network) to which network interface 1048 is connected (directly or indirectly) (e.g., network interface 1048 may be wirelessly connected to the network 110, in which case network interface 1048 is connected to an antenna arrangement); and a storage unit (a.k.a., “data storage system”) 1008, which may include one or more non-volatile storage devices and/or one or more volatile storage devices. In embodiments where PC 1002 includes a programmable processor, a computer readable medium (CRM) 1042 may be provided. CRM 1042 stores a computer program (CP) 1043 comprising computer readable instructions (CRI) 1044. CRM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes audio rendering apparatus 1000 to perform steps described herein (e.g., steps described herein with reference to the flow charts). In other embodiments, audio rendering apparatus 1000 may be configured to perform steps described herein without the need for code. That is, for example, PC 1002 may consist merely of one or more ASICs. Hence, the features of the embodiments described herein may be implemented in hardware and/or software.

### SUMMARY OF EMBODIMENTS

A1. A method (600) for rendering an audio source (102), the method comprising:
obtaining (s602) a target distance gain value, wherein the target distance gain value was derived using a target distance gain function (g_{target}) for the audio source and a reference distance value (r_{ref}) indicating a distance between a listening position and a reference point for the audio source (e.g., the reference point for the audio source is the point on an extent for the audio source that is closest to the listening position—the extent may be the actual extent of the audio source or a simplified extent (e.g., a line or rectangle) representing the audio source);
deriving (s604) a first gain correction value (c₁) for at least a first virtual source using the target distance gain value; and
rendering (s606) the audio source using the derived first gain correction value (c₁) and a signal for the first virtual source.

A2. The method of embodiment A1, further comprising obtaining a first source distance value (r₁) indicating a distance between a position of the first virtual source and the listening position, wherein the first gain correction value (c₁) for the first virtual source is derived further using the first source distance value (r₁).

A3. The method of embodiment A1 or A2, further comprising obtaining a distance gain value, wherein the distance gain value was derived using a source distance gain function (g₁) for the first virtual source, wherein the first gain correction value (c₁) for the first virtual source is derived further using the distance gain value.

A4. The method of any one of embodiments A1-A3, wherein the target distance gain value was derived by evaluating the target distance gain function at the reference distance value (r_{ref}).

A5. The method of any one of embodiments A1-A4, wherein
N virtual sources are configured to render the audio source,
N is a positive integer, and
the target distance gain value (g_{target} at r_{ref}) was derived further using N.

A6. The method of any one of embodiments A1-A5, wherein
the audio source is rendered using at least the first virtual source and a second virtual source,
the audio source is rendered using the derived first gain correction value for the first virtual source and using a second gain correction value for the second virtual source, and
the second gain correction value is equal to the derived first gain correction value.

A7. The method of any one of embodiments A1-A6, wherein
the audio source is rendered using at least the first virtual source and a second virtual source,
the audio source is rendered using the derived first gain correction value for the first virtual source and using a second gain correction value for the second virtual source, and
the second gain correction value (c₂) for the second virtual source is derived using the source distance gain function (g₁).

A8. The method of any one of embodiments A3-A6, wherein
the audio source is rendered using N virtual sources, where N is a positive integer,
each of the N virtual sources is associated with a source distance gain value obtained by evaluating one of one or more source distance gain functions at each source distance value indicating a distance between the listening position and a location of each virtual source, and
the first gain correction value is calculated using a combined value of the source distance gain values.

A8a. The method of embodiment A8, wherein
each of the N virtual sources is associated with an individual distance gain function, and
the source distance gain value associated with each of the N virtual sources is obtained by evaluating the individual distance gain function associated with each of the N virtual sources at each source distance value.

A9. The method of embodiment A8, wherein the combined value of the source distance gain values is a sum of squares of the source distance gain values.

A10. The method of embodiment A9, wherein the first gain correction value is equal to the target distance gain value divided by a square root of the combined value.

A11. The method of any one of embodiments A3-A10, wherein
the source distance gain function (gₙ) is equal to Cₙ/rₙ,
Cₙ is a source gain parameter associated with a first virtual source,
rₙ is the first source distance value, and
the source gain parameter is a constant or is determined based on the listening position.

A12. The method of any one of embodiments A3-A11, wherein the source distance gain function (gₙ) is equal to the target distance gain function (g_{target}) for the audio source.

A13. The method of any one of embodiments A3-A8 and A9-A10, wherein the source distance gain function (gₙ) is a constant.

A14. The method of any one of embodiments A3-A8 and A9-A10, wherein
the audio source is rendered using the first virtual source, a second virtual source, and a third virtual source,
the method further comprises obtaining a second gain correction value for the second virtual source and a third gain correction value for the third virtual source,
the second gain correction value is a present value (e.g., it does not depend on the listener position), and
the third gain correction value is equal to the first gain correction value.

A15. The method of embodiment A14, wherein
a second source distance value indicating a distance between the listening position and a position of the second virtual source is equal to the reference distance value, and
each of the first gain correction value and the third gain correction value is derived by evaluating the target distance gain function at the first source distance value and a third source distance value indicating a distance between the listening position and a position of the third virtual source.

B1. A method (650) for rendering an audio source (102) represented by at least a first virtual source and a second virtual source, the method comprising:
obtaining (s652) a reference distance value (r_{ref}) indicating a distance between a listening position and a reference point for the audio source;
obtaining (s654) a first distance value (r₁) indicating a distance between the listening position and the position of the first virtual source;
deriving (s656) a target distance gain value (gt) using r_{ref};
deriving (s658) a first distance gain value (g1) using r₁;
deriving (s660) a first gain correction value (a1) for the first virtual source using gt and g1; and
rendering (s662) the audio source using a1 and a first signal (s1) for the first virtual source.

B2. The method of claim B1, wherein rendering the audio source using a1 and s1 comprises producing a first modified signal (s1′), wherein s1′=a1×s1.

C1. A computer program (1043) comprising instructions (1044) which when executed by processing circuitry (1002) cause the processing circuitry to perform the method of any one of embodiments A1-B2.

C2. A carrier containing the computer program of embodiment C1, wherein the carrier is one of an electronic signal, an optical signal, a radio signal, and a computer readable storage medium.

D1. An apparatus (1000) for rendering an audio source (102), the apparatus being configured to:
obtain (s602) a target distance gain value, wherein the target distance gain value was derived using a target distance gain function (g_{target}) for the audio source and a reference distance value (r_{ref}) indicating a distance between a listening position and a reference point for the audio source (e.g., the reference point for the audio source is the point on an extent for the audio source that is closest to the listening position—the extent may be the actual extent of the audio source or a simplified extent (e.g., a line or rectangle) representing the audio source);
derive (s604) a first gain correction value (c₁) for at least a first virtual source using the target distance gain value; and
render (s606) the audio source using the derived first gain correction value (c₁) and a signal for the first virtual source.

D2. The apparatus of embodiment D1, wherein the apparatus is further configured to perform the method of any one of embodiments A2-A15.

E1. An apparatus (1000) for rendering an audio source (102) represented by at least a first virtual source and a second virtual source, the apparatus being configured to:
obtain (s652) a reference distance value (r_{ref}) indicating a distance between a listening position and a reference point for the audio source;
obtain (s654) a first distance value (r₁) indicating a distance between the listening position and the position of the first virtual source;
derive (s656) a target distance gain value (gt) using r_{ref};
derive (s658) a first distance gain value (g1) using r₁;
derive (s660) a first gain correction value (a1) for the first virtual source using gt and g1; and
render (s662) the audio source using a1 and a first signal (s1) for the first virtual source.

E2. The apparatus of embodiment E1, wherein the apparatus is further configured to perform the method of embodiment B2.

F1. An apparatus (1000), the apparatus comprising:
a memory (1042); and
processing circuitry (1002) coupled to the memory, wherein the apparatus is configured to perform the method of any one of embodiments A1-B2.

1. A method for rendering an audio source using a plurality of virtual sources, the plurality of virtual sources including a first virtual source, the method comprising:
obtaining a target distance gain value, wherein the target distance gain value was derived using a target distance gain function for the audio source and a reference distance value indicating a distance between a listening position and a reference point for the audio source;
deriving a first distance gain correction value for at least the first virtual source using the target distance gain value; and
rendering the audio source using the derived first distance gain correction value and a signal for the first virtual source.

2. The method of claim 1, further comprising:
obtaining a first source distance value indicating a distance between a position of the first virtual source and the listening position, wherein
the first distance gain correction value for the first virtual source is derived further using the first source distance value.

3. The method of claim 1, further comprising:
obtaining a distance gain value, wherein the distance gain value was derived using a source distance gain function for the first virtual source, wherein
the first distance gain correction value for the first virtual source is derived further using the distance gain value.

4. The method of claim 1, wherein the target distance gain value was derived by evaluating the target distance gain function at the reference distance value.

5. The method of claim 1, wherein
the audio source is rendered using at least the first virtual source and a second virtual source,
the audio source is rendered using the derived first distance gain correction value for the first virtual source and using a second distance gain correction value for the second virtual source, and
the second distance gain correction value is the same as the derived first distance gain correction value.

6. The method of claim 1, wherein
the audio source is rendered using at least the first virtual source and a second virtual source,
the audio source is rendered using the derived first distance gain correction value for the first virtual source and using a second distance gain correction value for the second virtual source, and
the second distance gain correction value for the second virtual source is derived using the source distance gain function.

7. The method of claim 1, wherein
the audio source is rendered using N virtual sources, where N is a positive integer,
each of the N virtual sources is associated with a source distance gain value obtained by evaluating one of one or more source distance gain functions at each source distance value indicating a distance between the listening position and a location of each virtual source, and
the first distance gain correction value is calculated using a combined value of the source distance gain values.

8. The method of claim 7, wherein the source distance gain value associated with each of the N virtual sources is obtained by evaluating the same source distance gain function.

9. The method of claim 7, wherein the first distance gain correction value is calculated based on a ratio of the target distance gain value and the combined value of the source distance gain values.

10. The method of claim 7, wherein the combined value of the source distance gain values is determined based on a sum of squares of the source distance gain values or a sum of the source distance gain values.

11. The method of claim 10, wherein
the sum of squares of the source distance gain values is a weighted sum of squares of the source distance gain values, or
the sum of the source distance gain values is a weighted sum of the source distance gain values.

12. The method of claim 7, wherein the first distance gain correction value is equal to the target distance gain value divided by either the combined value or a square root of the combined value.

13. The method of claim 3, wherein
the source distance gain function for the first virtual source is proportional to A/r₁,
A is a constant, and
r₁ is the first source distance value.

14. The method of claim 3, wherein
the source distance gain function for the first virtual source is equal to the target distance gain function for the audio source, or
the source distance gain function is a constant.

15. (canceled)

16. The method of claim 1, wherein the first distance gain correction value is a common distance gain correction value that is common for all virtual sources used for rendering the audio source.

17. The method of claim 16, wherein the common distance gain correction value is calculated based on:
$$\frac{{g}_{target} ( {r}_{r e f} )}{\sqrt{{\sum }_{n = 1}^{N} {s}_{n}^{2} ( {r}_{n} ) {g}_{n}^{2} ( {r}_{n} )}} ,$$
where r_{ref} is the reference distance value, g_{target}(r_{ref}) is the target distance gain value, N is the number of virtual sources used for rendering the audio source, rₙ is a distance between the listening position and n-th virtual source, sₙ(rₙ) is a source gain value for the n-th virtual source at rₙ, and gₙ(rₙ) is a value of a distance gain function for the n-th virtual source at rₙ.

18-19. (canceled)

20. A method for rendering an audio source represented by at least a first virtual source and a second virtual source, the method comprising:
obtaining a reference distance value indicating a distance between a listening position and a reference point for the audio source;
obtaining a first distance value indicating a distance between the listening position and the position of the first virtual source;
deriving a target distance gain value using the reference distance value;
deriving a first distance gain value using the first distance value;
deriving a first distance gain correction value for the first virtual source using the target distance gain value and the first distance gain value; and
rendering the audio source using the first distance gain correction value and a first signal for the first virtual source.

21. The method of claim 20, wherein rendering the audio source using the first distance gain correction value (a) and the first signal (s1) for the first virtual source comprises producing a first modified signal (s1′), wherein s1′=a1×s1.

22-30. (canceled)

31. An apparatus for rendering an audio source using a plurality of virtual sources, the plurality of virtual sources including a first virtual source, the apparatus being configured to:
obtain a target distance gain value, wherein the target distance gain value was derived using a target distance gain function for the audio source and a reference distance value indicating a distance between a listening position and a reference point for the audio source;
derive a first distance gain correction value for at least the first virtual source using the target distance gain value; and
render the audio source using the derived first distance gain correction value and a signal for the first virtual source.

32-34. (canceled)

35. An apparatus for rendering an audio source represented by at least a first virtual source and a second virtual source, the apparatus being configured to:
obtain a reference distance value indicating a distance between a listening position and a reference point for the audio source;
obtain a first distance value indicating a distance between the listening position and the position of the first virtual source;
derive a target distance gain value using the reference distance value;
derive a first distance gain value using the first distance value;
derive a first distance gain correction value for the first virtual source using the target distance gain value and the first distance gain value; and
render the audio source using the first distance gain correction value and a first signal for the first virtual source.

36-39. (canceled)
